(19) United States
(12) Patent Application Publication
(10) Pub. No.: US 2026/0153659 A1
(43) Pub. Date: Jun. 4, 2026

(54) OPTICAL FILTER

(71) Applicant: AGC Inc., Tokyo (JP)

(72) Inventors: Takashi NAGATA, Shizuoka (JP); Takahiro SAKAGAMI, Shizuoka (JP); Kanako OHGUCHI, Shizuoka (JP); Kazuhiko SHIONO, Fukushima (JP); Kiyokazu ENDO, Fukushima (JP)

(73) Assignee: AGC Inc., Tokyo (JP)

(21) Appl. No.: 19/460,440

(22) Filed: Jan. 27, 2026

Related U.S. Application Data
(63) Continuation of application No. PCT/JP2024/029520, filed on Aug. 20, 2024.

(30) Foreign Application Priority Data
Aug. 23, 2023 (JP) 2023-135694

(51) Int. Cl. G02B 5/28; G02B 5/00; G02B 5/22

(52) U.S. Cl. CPC G02B 5/285; G02B 5/003; G02B 5/226

(57) ABSTRACT

An optical filter includes: a phosphate glass; a dielectric multilayer film 1 and a dielectric multilayer film 2 provided on both surface sides of the phosphate glass; a barrier film 1 provided between the phosphate glass and the dielectric multilayer film 1; a barrier film 2 provided between the phosphate glass and the dielectric multilayer film 2; and a light-absorbing layer provided on or above the dielectric multilayer film 2, in which the phosphate glass has near-infrared ray absorbing properties, is substantially free from fluorine atoms, and has a thickness of 0.3 mm or less, the light-absorbing layer includes a near-infrared ray absorbing dye, the barrier film 1 and the barrier film 2 each independently include one or more selected from TiO₂, Nb₂O₅, Ta₂O₅, and HfO₂, and the optical filter satisfies all of spectral characteristics (i-1) to (i-5).

### CROSS-REFERENCE TO RELATED APPLICATIONS

This is a bypass continuation of International Patent Application No. PCT/JP2024/029520, filed on Aug. 20, 2024, which claims priority to Japanese Patent Application No. 2023-135694, filed on Aug. 23, 2023. The contents of these applications are hereby incorporated by reference in their entireties.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible wavelength region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated on one surface or both surfaces of a transparent substrate (dielectric multilayer film) and light to be shielded is reflected by utilizing interference of light, an absorption type filter in which light to be shielded is absorbed by using a glass or a dye that absorbs light in a specific wavelength region, and a filter in which a reflection type filter and an absorption type filter are combined.

Here, a phosphate glass is known as the glass that absorbs light, but is easily affected by moisture or the like in the environment, and there is a concern that phosphoric acid is eluted to decompose other constituent materials of the optical filter. Therefore, a technique for preventing elution of phosphoric acid has been studied.
Patent Literature 1 discloses a phosphate glass having a protective film formed by coating a surface with alumina in order to improve moisture resistance.
Patent Literature 2 discloses an infrared cut filter in which a cover glass and an infrared ray absorbing glass such as a phosphate glass are bonded to each other via an adhesive in order to increase moisture resistance.
Patent Literature 3 discloses an infrared cut filter using a fluorophosphate glass.

### CITATION LIST

### Patent Literature

Patent Literature 1: JPH04-139035A
Patent Literature 2: JP2016-18092A
Patent Literature 3: WO2019/151348

### SUMMARY OF INVENTION

However, in the technique disclosed in Patent Literature 1, the surface of the phosphate glass covered with the alumina protective film is hardly affected by moisture, and the moisture resistance is improved, but a reaction between the moisture and an end surface of the glass not covered with the protective film cannot be prevented, and there is a concern that the phosphoric acid eluted from the end surface of the glass reacts with the alumina protective film to cause film peeling due to reduction in adhesion.

In the technique disclosed in Patent Literature 2, since the adhesive is an organic material, moisture is likely to penetrate from the vicinity of an end surface. Therefore, there is a concern that the adhesive is deteriorated by the phosphoric acid eluted from the glass and the adhesion is reduced.

In an optical filter including a dielectric multilayer film, since an optical film thickness of the dielectric multilayer film changes depending on an incident angle of light, there is a problem that a spectral transmittance curve changes depending on the incident angle. In particular, with the reduction in height of a camera module in recent years, reduction in thickness of the entire optical filter is required, and use under a condition of a high incident angle is assumed, and therefore an optical filter that is less likely to be affected by an incident angle is required.

The fluorophosphate glass disclosed in Patent Literature 3 is excellent in moisture resistance, but has a small near-infrared light absorption ability, and thus it is necessary to enhance reflection characteristics of the dielectric multilayer film in order to compensate for this. However, a dielectric multilayer film having strong reflection characteristics is easily affected by the incident angle, and a transmittance of visible light may be reduced.

An object of the present invention is to provide an optical filter excellent in moisture resistance, capable of realizing a reduction in thickness, and excellent in transmittance in a visible light region and shielding properties in a near-infrared region even at a high incident angle.

The present invention provides an optical filter having the following configuration.

An optical filter including:
a phosphate glass;
a dielectric multilayer film 1 and a dielectric multilayer film 2 provided on both surface sides of the phosphate glass;
a barrier film 1 provided between the phosphate glass and the dielectric multilayer film 1;
a barrier film 2 provided between the phosphate glass and the dielectric multilayer film 2; and
a light-absorbing layer provided on or above the dielectric multilayer film 2, in which
the phosphate glass has near-infrared ray absorbing properties, is substantially free from fluorine atoms, and has a thickness of 0.3 mm or less,
the light-absorbing layer includes a near-infrared ray absorbing dye,
the barrier film 1 and the barrier film 2 each independently include one or more selected from TiO₂, Nb₂O₅, Ta₂O₅, and HfO₂, and
the optical filter satisfies all of the following spectral characteristics (i-1) to (i-5):
(i-1) an average transmittance at a wavelength of 440 nm to 500 nm is 75% or more at an incident angle of 0 degrees and 60% or more at an incident angle of 60 degrees,
(i-2) an average transmittance at a wavelength of 750 nm to 1,000 nm is 2% or less at an incident angle of 0 degrees and 2% or less at an incident angle of 60 degrees,
(i-3) in a spectral transmittance curve at an incident angle of 0 degrees, a wavelength IR 10_{(0 deg)} at which a transmittance is 10% is in a range of 600 nm to 700 nm,
(i-4) an absolute value of a difference between the wavelength IR 10_{(0 deg)} at which the transmittance is 10% in the range of 600 nm to 700 nm in the spectral transmittance curve at an incident angle of 0 degrees and a wavelength IR 10_{(60 deg)} at which a transmittance is 10% in the range of 600 nm to 700 nm in a spectral transmittance curve at an incident angle of 60 degrees is 15 nm or less, and
(i-5) a transmittance at a wavelength of 1,100 nm is 5% or less at an incident angle of 0 degrees and 5% or less at an incident angle of 60 degrees.

According to the present invention, an optical filter excellent in moisture resistance, capable of realizing a reduction in thickness, and excellent in transmittance in a visible light region and shielding properties in a near-infrared region even at a high incident angle can be provided.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating a spectral transmittance curve of a glass 4.

FIG. 4 is a diagram illustrating a spectral transmittance curve of a light-absorbing layer.

FIG. 5 is a diagram illustrating spectral reflectance curves of a dielectric multilayer film 1A and a barrier film 1.

FIG. 6 is a diagram illustrating spectral reflectance curves of a dielectric multilayer film 1B and the barrier film 1.

FIG. 7 is a diagram illustrating spectral transmittance curves of an optical filter of Example 2-8.

FIG. 8 is a diagram illustrating spectral reflectance curves (on light-absorbing layer side) of the optical filter in Example 2-8.

FIG. 9 is a diagram illustrating spectral reflectance curves (on dielectric multilayer film 1 side) of the optical filter in Example 2-8.

### DESCRIPTION OF EMBODIMENTS

Hereinafter, embodiments of the present invention will be described.

In the present description, a near-infrared ray absorbing dye may be abbreviated as an “NIR dye”, and an ultraviolet ray absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, spectra of a transmittance of a glass, a light-absorbing layer including a case where a dye is contained in a resin, a transmittance measured by dissolving a dye in a solvent such as dichloromethane, a transmittance of a dielectric multilayer film, and a transmittance of an optical filter having the dielectric multilayer film are all “external (measured) transmittance” including reflection losses of front and back surfaces even when described as “transmittance”.

In the present description, a transmittance of, for example, 90% or more in a specific wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance is 1% or less in the wavelength region. An average transmittance in the specific wavelength region is an arithmetic mean of transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “present filter”) includes a phosphate glass, a dielectric multilayer film 1 and a dielectric multilayer film 2 provided on both surface sides of the phosphate glass, and a light-absorbing layer provided on or above the dielectric multilayer film 2. The present filter further includes a barrier film 1 between the phosphate glass and the dielectric multilayer film 1, and a barrier film 2 between the phosphate glass and the dielectric multilayer film 2. The barrier films 1 and 2 contain a specific material as to be described later. Such barrier films prevent the phosphate glass from reacting with moisture in the environment, and an optical filter having excellent moisture resistance is obtained. Further, since the phosphate glass has a thickness of 0.3 mm or less, reduction in thickness of the optical filter can be realized.

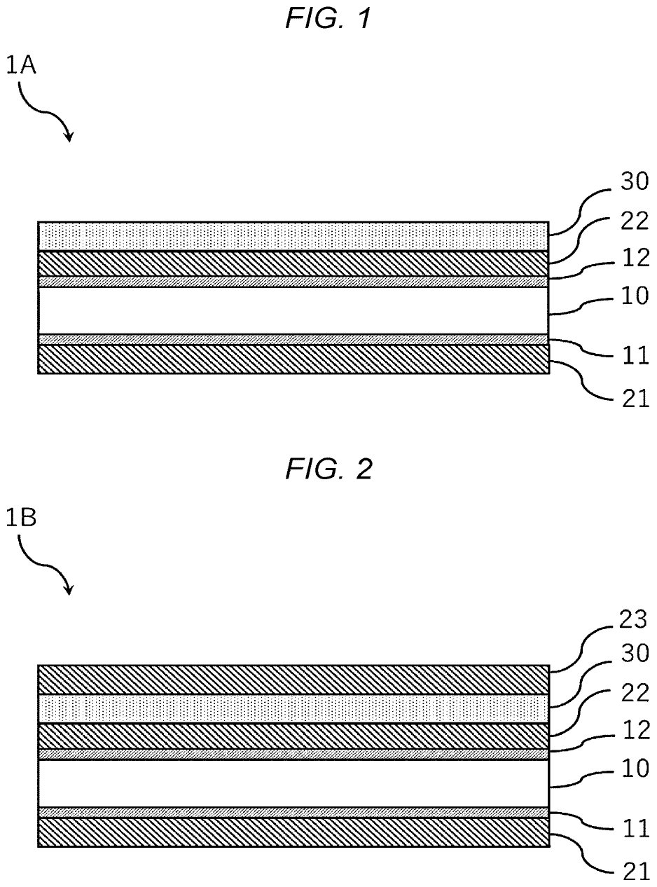

An example of a configuration of the present filter will be described with reference to the drawings. FIGS. 1 and 2 are cross-sectional views schematically illustrating examples of an optical filter according to one embodiment.

An optical filter 1A illustrated in FIG. 1 is an example including: a phosphate glass 10; a dielectric multilayer film 21 provided on one main surface side of the phosphate glass 10; a dielectric multilayer film 22 provided on the other main surface side of the phosphate glass 10; a light-absorbing layer 30 provided on the dielectric multilayer film 22; a barrier film 11 provided between the phosphate glass 10 and the dielectric multilayer film 21; and a barrier film 12 provided between the phosphate glass 10 and the dielectric multilayer film 22.

An optical filter 1B illustrated in FIG. 2 is an example further including a dielectric multilayer film 23 laminated on a surface of the light-absorbing layer 30.

The optical filter according to an embodiment of the present invention satisfies all of the following spectral characteristics (i-1) to (i-5).
(i-1) An average transmittance at a wavelength of 440 nm to 500 nm is 75% or more at an incident angle of 0 degrees and 60% or more at an incident angle of 60 degrees.
(i-2) An average transmittance at a wavelength of 750 nm to 1,000 nm is 2% or less at an incident angle of 0 degrees and 2% or less at an incident angle of 60 degrees.
(i-3) In a spectral transmittance curve at an incident angle of 0 degrees, a wavelength IR 10_{(0 deg)} at which a transmittance is 10% is in a range of 600 nm to 700 nm.
(i-4) An absolute value of a difference between the wavelength IR10_{(0 deg)} at which the transmittance is 10% in the range of 600 nm to 700 nm in the spectral transmittance curve at an incident angle of 0 degrees and a wavelength IR 10_{(60 deg)} at which a transmittance is 10% in the range of 600 nm to 700 nm in a spectral transmittance curve at an incident angle of 60 degrees is 15 nm or less.
(i-5) A transmittance at a wavelength of 1,100 nm is 5% or less at an incident angle of 0 degrees and 5% or less at an incident angle of 60 degrees.

The present filter satisfying all of the spectral characteristics (i-1) to (i-5) is an optical filter excellent in transmittance of visible light as shown in the characteristic (i-1), excellent in shielding properties of near-infrared light at a wavelength of 750 nm to 1,000 nm as shown in the characteristic (i-2), in particular, in shielding properties of near-infrared light at a wavelength of 1,100 nm as shown in the characteristic (i-5), and having a transmittance less likely to shift even at a high incident angle as shown in the characteristic (i-4).

Satisfying the spectral characteristic (i-1) means that a transmittance in a visible light region of 440 nm to 500 nm is excellent even at a high incident angle.

The average transmittance at a wavelength of 440 nm to 500 nm is preferably 80% or more, more preferably 85% or more at an incident angle of 0 degrees, and is preferably 75% or more, more preferably 80% or more at an incident angle of 60 degrees.

In addition, in order to satisfy the spectral characteristic (i-1), for example, a dielectric multilayer film, a phosphate glass, or a near-infrared light absorbing dye having an excellent transmittance in the visible light region may be used.

Satisfying the spectral characteristic (i-2) means that the shielding properties in a near-infrared region of 750 nm to 1,000 nm are excellent even at a high incident angle.

The average transmittance at a wavelength of 750 nm to 1,000 nm is preferably 1.5% or less, more preferably 1% or less, and further preferably 0.5% or less at an incident angle of 0 degrees, and is preferably 1% or less, more preferably 0.5% or less, and further preferably 0.4% or less at an incident angle of 60 degrees.

In addition, in order to satisfy the spectral characteristic (i-2), for example, light may be shielded by an absorption ability of the phosphate glass and the near-infrared light absorbing dye.

Satisfying the spectral characteristic (i-3) means that a wavelength region of 600 nm to 700 nm is a region in which a spectral transmittance curve rises from a near-infrared shielding region to a visible light transmission region.

The wavelength IR10_{(0 deg)} is preferably in a range of 610 nm to 695 nm, and more preferably in a range of 620 nm to 690 nm.

Satisfying the spectral characteristic (i-4) means that the spectral transmittance curve is less likely to shift in a wavelength region of 600 nm to 700 nm even at a high incident angle. The absolute value of the difference between the wavelength IR 10_{(0 deg)} and the wavelength IR 10_{(60 deg)} is preferably 14 nm or less, and more preferably 13 nm or less.

In addition, in order to satisfy the spectral characteristic (i-4), for example, light in the wavelength region of 600 nm to 700 nm may be shielded by an absorption ability of the phosphate glass and the near-infrared light absorbing dye that are not affected by the incident angle.

Satisfying the spectral characteristic (i-5) means that the shielding properties in a near-infrared region of 1,100 nm are excellent even at a high incident angle.

The transmittance at a wavelength of 1,100 nm is preferably 4% or less, more preferably 3% or less, further preferably 2% or less, still further preferably 1% or less, and most preferably 0.7% or less at an incident angle of 0 degrees, and is preferably 4% or less, more preferably 3% or less, further preferably 2% or less, still further preferably 1% or less, and most preferably 0.4% or less at an incident angle of 60 degrees.

In addition, in order to satisfy the spectral characteristic (i-5), for example, light may be shielded by an absorption ability of the phosphate glass.

The optical filter according to the present embodiment preferably satisfies the following spectral characteristic (i-6).
(i-6) A maximum transmittance at a wavelength of 750 nm to 1,000 nm is 2% or less at an incident angle of 0 degrees and 2% or less at an incident angle of 60 degrees.

Satisfying the spectral characteristic (i-6) means that the shielding properties in the near-infrared region of 750 nm to 1,000 nm are excellent even at a high incident angle.

The maximum transmittance at a wavelength of 750 nm to 1,000 nm is preferably 1.5% or less, more preferably 1.0% or less at an incident angle of 0 degrees, and is preferably 1.0% or less, more preferably 0.5% or less at an incident angle of 60 degrees.

In addition, in order to satisfy the spectral characteristic (i-6), for example, light may be shielded by an absorption ability of the phosphate glass and the near-infrared light absorbing dye.

The optical filter according to the present embodiment preferably satisfies the following spectral characteristic (i-8).
(1-8) When a light is incident from a light-absorbing layer side, a maximum reflectance at a wavelength of 450 nm to 950 nm is 35% or less at an incident angle of 5 degrees, and is 35% or less at an incident angle of 60 degrees.

Satisfying the spectral characteristic (i-8) means that reflection characteristics at a wavelength of 450 nm to 950 nm are reduced in the incident direction of external light. This is preferable in that a phenomenon in which light is generated outside an originally assumed optical path, that is, so-called stray light can be prevented.

The maximum reflectance at a wavelength of 450 nm to 950 nm is preferably 15% or less, more preferably 10% or less at an incident angle of 5 degrees, and is preferably 25% or less, more preferably 20% or less at an incident angle of 60 degrees.

In order to satisfy the spectral characteristic (i-8), for example, an antireflection film may be laminated on the light-absorbing layer.

The optical filter according to the present embodiment preferably satisfies the following spectral characteristic (i-9).
(i-9) When a light is incident from a dielectric multilayer film 1 side, a maximum reflectance at a wavelength of 450 nm to 950 nm is 20% or less at an incident angle of 5 degrees, and is 20% or less at an incident angle of 60 degrees.

Satisfying the spectral characteristic (i-9) means that reflection characteristics at a wavelength of 450 nm to 950 nm are reduced in an incident direction on a sensor side. This is preferable in that a phenomenon in which light is generated outside an originally assumed optical path, that is, so-called stray light can be prevented by re-reflecting light reflected by a sensor surface by a surface of the dielectric multilayer film 1 and incident the light.

The maximum reflectance at a wavelength of 450 nm to 950 nm is preferably 15% or less, more preferably 10% or less at an incident angle of 5 degrees, and is preferably 15% or less, more preferably 10% or less at an incident angle of 60 degrees.

In order to satisfy the spectral characteristic (i-9), for example, a dielectric multilayer film 1 having a low reflectance at a wavelength of 450 nm to 950 nm may be used.

The optical filter according to the present embodiment preferably satisfies the following spectral characteristic (i-10).

(i-10) An absolute value of a difference between an average transmittance at an incident angle of 0 degrees and an average transmittance at an incident angle of 60 degrees at a wavelength of 440 nm to 500 nm is 15% or less.

Satisfying the spectral characteristic (i-10) means that a transmittance change (ripple) of visible light is small even at a high incident angle.

The above absolute value is more preferably 10% or less.

In order to satisfy the spectral characteristic (i-10), a dielectric multilayer film having a small transmittance change (ripple) of visible light even at a high incident angle may be used.

The optical filter according to the present embodiment preferably satisfies the following spectral characteristic (i-11).
(i-11) An average transmittance at a wavelength of 900 nm to 1,000 nm is 1% or less at an incident angle of 0 degrees.

Satisfying the spectral characteristic (i-11) means that shielding properties of near-infrared light at a wavelength of 900 nm to 1,000 nm are excellent.

The average transmittance at a wavelength of 900 nm to 1,000 nm is more preferably 0.5% or less at an incident angle of 0 degrees.

In order to satisfy the spectral characteristic (i-11), for example, light may be shielded in such a region by combining an absorption ability of the phosphate glass and reflection characteristics of the dielectric multilayer film.

### <Phosphate Glass>

The optical filter according to the present embodiment includes the phosphate glass. In the present description, the phosphate glass means a glass containing 40% or more of P₂O₅ in terms of mol % based on oxides and is substantially free from fluorine atoms. Here, the expression of “substantially free from” means that when a content of a component element other than the fluorine atom contained in the glass is defined as 100 mass %, and a content of the fluorine atom contained in the glass is indicated in terms of outer percentage, the content of the fluorine atom is less than 3 mass % in terms of outer percentage.

The phosphate glass has near-infrared ray absorbing properties and also functions as a support for the optical filter. In addition, since light is shielded by the absorbing properties, light-shielding properties are less likely to be affected by the incident angle unlike the dielectric multilayer film.

The phosphate glass preferably has, in terms of a plate thickness of 0.25 mm, an average transmittance of 70% or more at a wavelength of 440 nm to 500 nm, a transmittance of 5.5% or less at a wavelength of 1,200 nm, a transmittance of 1.0% or less at a wavelength of 1,000 nm, and a transmittance of 1.5% or less at a wavelength of 800 nm. A phosphate glass satisfying such spectral characteristics is preferable because it has a sufficient transmittance of visible light and excellent near-infrared light absorption ability.

The average transmittance at a wavelength of 440 nm to 500 nm is more preferably 80% or more.

The transmittance at a wavelength of 1,200 nm is more preferably 5% or less.

The transmittance at a wavelength of 1,000 nm is more preferably 0.5% or less.

The transmittance at a wavelength of 800 nm is more preferably 1.0% or less.

Each component that can form the phosphate glass and a suitable content thereof is described below. In the present description, unless otherwise specified, a content of each component and a total content are expressed in terms of mol % based on oxides.

The phosphate glass is substantially free from no fluorine atoms, and preferably contains, in terms of mol % based on oxides,
40% to 75% of P₂O₅,
10% to 30% of Al₂O₃,
0.1% to 30% of ΣR₂O (where R₂O is one or more components selected from Li₂O, Na₂O, K₂O, Rb₂O, and Cs₂O, and ΣR₂O is a total content of R₂O),
0% to 30% of ΣR′O (where R′O is one or more components selected from CaO, MgO, BaO, SrO, and ZnO, and ΣR′O is a total content of R′O), and
2% to 30% of CuO.

P₂O₅ is a main component forming the glass, and is a component for enhancing a near-infrared ray cutting property. When a content of P₂O₅ is 40% or more, an effect thereof can be sufficiently obtained, and when the content of P₂O₅ is 75% or less, problems such as glass instability and reduction in weather resistance are less likely to occur. Therefore, the content of P₂O₅ is preferably 40% to 75%, more preferably 45% to 75%, further preferably 50% to 70%, still further preferably 52% to 65%, particularly preferably 54% to 65%, and most preferably 55% to 60%.

Al₂O₃ is a main component forming the glass, and is a component for enhancing the strength of the glass, enhancing the weather resistance of the glass, and the like. When the content of Al₂O₃ is 10% or more, an effect thereof can be sufficiently obtained, and when the content of Al₂O₃ is 30% or less, problems such as glass instability and reduction in near-infrared ray cutting property are less likely to occur. Therefore, the content of Al₂O₃ is preferably 10% to 30%, more preferably 11% to 27%, further preferably 12% to 26%, still further preferably 12.5% to 25%, and most preferably 13% to 24.5%. When the content of Al₂O₃ is 13% or more, the weather resistance of the glass can be particularly enhanced.

R₂O (where R₂O is one or more components selected from Li₂O, Na₂O, K₂O, Rb₂O, and Cs₂O) is a component for lowering a melting temperature of the glass, lowering a liquid phase temperature of the glass, stabilizing the glass, and the like. When a total content of R₂O (ΣR₂O) is 0.1% or more, an effect thereof can be sufficiently obtained, and when the total content of R₂O is 30% or less, glass instability is less likely to occur, which is preferable. Therefore, the total content of R₂O is preferably 1% to 25%, more preferably 2% to 20%, further preferably 3% to 18%, still further preferably 4% to 17%, and most preferably 5% to 18%.

Li₂O is a component for lowering the melting temperature of the glass, lowering the liquid phase temperature of the glass, stabilizing the glass, and the like. A content of Li₂O is preferably 0% to 20%. When the content of Li₂O is 20% or less, problems such as glass instability and reduction in near-infrared ray cutting property are less likely to occur, which is preferable. The content of Li₂O is more preferably 0% to 15%, further preferably 0% to 10%, and still further preferably 0% to 5%. Most preferably, Li₂O is not substantially contained. In the present invention, the expression of “a specific component is not substantially contained” means that the component is not intentionally added, and does not exclude inclusion of the component to the extent that the component is unavoidably mixed in from raw materials, or the like, and does not affect desired properties.

Na₂O is a component for lowering the melting temperature of the glass, lowering the liquid phase temperature of the glass, stabilizing the glass, and the like. A content of Na₂O is preferably 0% to 25%. When the content of Na₂O is 25% or less, glass instability is less likely to occur, which is preferable. The content of Na₂O is more preferably 0.5% to 20%, further preferably 1% to 15%, and still further preferably 2% to 10%.

K₂O is a component having effects such as lowering the melting temperature of the glass and lowering the liquid phase temperature of the glass. A content of K₂O is preferably 0% to 25%. When the content of K₂O is 25% or less, glass instability is less likely to occur, which is preferable. The content of K₂O is more preferably 0.5% to 20%, further preferably 1% to 15%, and still further preferably 2% to 13%.

Rb₂O is a component having effects such as lowering the melting temperature of the glass and lowering the liquid phase temperature of the glass. A content of Rb₂O is preferably 0% to 25%. When the content of Rb₂O is 25% or less, glass instability is less likely to occur, which is preferable. The content of Rb₂O is more preferably 0.5% to 20%, further preferably 1% to 15%, and still further preferably 2% to 10%.

Cs₂O is a component having effects such as lowering the melting temperature of the glass and lowering the liquid phase temperature of the glass. A content of Cs₂O is preferably 0% to 25%. When the content of Cs₂O is 25% or less, glass instability is less likely to occur, which is preferable. The content of Cs₂O is more preferably 0.5% to 20%, further preferably 1% to 15%, and still further preferably 2% to 10%.

When two or more of the above alkali metal components represented by R₂O are added at the same time, a mixed alkali effect is generated in the glass, and a mobility of R⁺ ions is reduced. Accordingly, when the glass comes into contact with water, a hydration reaction caused by ion exchange between H⁺ ions in water molecules and the R ions in the glass is inhibited, and the weather resistance of the glass is improved. Therefore, the glass of the present embodiment preferably contains two or more components selected from Li₂O, Na₂O, K₂O, Rb₂O, and Cs₂O. In this case, the total content (ΣR₂O) of R₂O (where R₂O is two or more components selected from Li₂O, Na₂O, K₂O, Rb₂O, and Cs₂O) is preferably 6% to 18% (where 7% is excluded). When the total content of R₂O is 6% or more, an effect thereof can be sufficiently obtained, and when the total content of R₂O is 18% or less, problems such as glass instability, reduction in near-infrared ray cutting property, and reduction in strength of the glass are less likely to occur, which is preferable. Therefore, ΣR₂O is preferably 7% to 18%, more preferably 8% to 18%, further preferably 9% to 18%, still further preferably 10% to 18%, and most preferably 10.5% to 18%.

R′O (where R′O is one or more components selected from CaO, MgO, BaO, SrO, and ZnO) is a component for lowering the melting temperature of the glass, lowering the liquid phase temperature of the glass, stabilizing the glass, enhancing the strength of the glass, and the like. A total content of R′O (ΣR′O) is preferably 0% to 30%. When the total content of R′O is 30% or less, problems such as glass instability, reduction in near-infrared ray cutting property, reduction in transmittance of short wavelength infrared rays, and reduction in strength of the glass are less likely to occur, which is preferable. The total content of R′O is more preferably 0% to 25%, and further preferably 0% to 20%. The total content of R′O is still further preferably 0% to 15%, and still further preferably 0% to 10%.

Preferably, the glass of the present embodiment is substantially free from divalent cation other than Cu. The reason for this will be described below. In a case where the glass of the present embodiment contains CuO, light in a near-infrared ray region is cut by light absorption of Cu²⁺ ions. The light absorption is caused by electron transition between d-orbits of Cu²⁺ ions split by an electric field of O²⁻ ions. The splitting of d-orbits is promoted when symmetry of the O²⁻ ions existing around the Cu²⁺ ions is reduced. For example, when cations exist around the O²⁻ ions, the O²⁻ ions are attracted by an electric field of the cations, and the symmetry of the O²⁻ ions is reduced. As a result, the splitting of d-orbits is promoted, and the light absorption occurs due to the electron transition between the split d-orbits, and thus a light absorption ability in the near-infrared region is weakened, and a light absorption ability in a short wavelength infrared region is strengthened. Since the strength of the electric field of the cations becomes stronger when the valence of ions is large, in particular, when an oxide containing divalent cations other than Cu is added to the glass, there is a concern that the near-infrared ray cutting property is reduced and a transmittance of the short wavelength infrared rays is reduced.

CaO is a component for lowering the melting temperature of the glass, lowering the liquid phase temperature of the glass, stabilizing the glass, enhancing the strength of the glass, and the like. A content of CaO is preferably 0% to 20%. When the content of CaO is 20% or less, problems such as glass instability, reduction in near-infrared ray cutting property, and reduction in transmittance of short wavelength infrared rays are less likely to occur, which is preferable. The content of CaO is more preferably 0% to 15%, further preferably 0% to 10%, and still further preferably 0% to 5%. Most preferably, CaO is not substantially contained.

MgO is a component for lowering the melting temperature of the glass, lowering the liquid phase temperature of the glass, stabilizing the glass, enhancing the strength of the glass, and the like. A content of MgO is preferably 0% to 20%. When the content of MgO is 20% or less, problems such as glass instability, reduction in near-infrared ray cutting property, and reduction in transmittance of short wavelength infrared rays are less likely to occur, which is preferable. The content of MgO is more preferably 0% to 15%, further preferably 0% to 10%, and still further preferably 0% to 5%. Most preferably, MgO is not substantially contained.

BaO is a component for lowering the melting temperature of the glass, lowering the liquid phase temperature of the glass, stabilizing the glass, and the like. A content of BaO is preferably 0% to 20%. When the content of BaO is 20% or less, problems such as glass instability, reduction in near-infrared ray cutting property, and reduction in transmittance of short wavelength infrared rays are less likely to occur, which is preferable. The content of BaO is more preferably 0% to 15%, further preferably 0% to 10%, and still further preferably 0% to 5%. The content of BaO may be 0.1% or more. Most preferably, BaO is not substantially contained.

SrO is a component for lowering the melting temperature of the glass, lowering the liquid phase temperature of the glass, stabilizing the glass, and the like. A content of SrO is preferably 0% to 20%. When the content of SrO is 20% or less, problems such as glass instability, reduction in near-infrared ray cutting property, and reduction in transmittance of short wavelength infrared rays are less likely to occur, which is preferable. The content of SrO is more preferably 0% to 15%, and further preferably 0% to 10%. Most preferably, SrO is not substantially contained.

ZnO has effects such as lowering the melting temperature of the glass and lowering the liquid phase temperature of the glass. A content of ZnO is preferably 0% to 20%. When the content of ZnO is 20% or less, problems such as deterioration of the solubility of the glass, reduction in near-infrared ray cutting property, and reduction in transmittance of short wavelength infrared rays are less likely to occur, which is preferable. The content of ZnO is more preferably 0% to 15%, further preferably 0% to 10%, and still further preferably 0% to 5%. Most preferably, ZnO is not substantially contained.

CuO is a component for cutting near-infrared rays. A content of CuO is preferably 2% to 30%. When the content of CuO is 2% or more, an effect thereof can be sufficiently obtained, and when the content of CuO is 30% or less, problems such as reduction in transmittance in the visible light region and reduction in transmittance in the short wavelength infrared region are less likely to occur, which is preferable. The content of CuO is more preferably 5% to 25%, further preferably 8% to 20%, and still further preferably 11% to 18%. The content of CuO is yet still further preferably 12% or more. In particular, in a case where the glass is substantially free from divalent cation other than Cu, when the content of CuO is 12% or more, the cutting property of the near-infrared ray and the transmittance of the short wavelength infrared ray can be further enhanced. The content of CuO is most preferably 13% to 18%.

B₂O₃ may be contained in a range of 15% or less for stabilizing the glass. When the content of B₂O₃ is 15% or less, problems such as deterioration of weather resistance of the glass, reduction in near-infrared ray cutting property, and reduction in transmittance of short wavelength infrared rays are less likely to occur, which is preferable. The content of B₂O₃ is preferably 13% or less, more preferably 11% or less, further preferably 9% or less, and still further preferably 7% or less. Most preferably, B₂O₃ is not substantially contained.

MoO₃ is a component for increasing the transmittance of light in the visible region of the glass. When a content of MoO₃ is 0.1% or more, the effect of increasing the transmittance of light in the visible region of the glass can be sufficiently obtained, and when the content of MoO₃ is 5% or less, problems such as reduction in near-infrared ray cutting property and generation of devitrification foreign matters in the glass are less likely to occur, which is preferable. The content of MoO₃ is more preferably 0.1% to 4.5%, further preferably 0.1% to 4%, still further preferably 0.1% to 3.5%, and most preferably 0.1% to 3%.

In the glass of the present embodiment, F (fluorine atom) is an effective component for increasing the weather resistance, but F is an environmental load substance and there is a concern that the near-infrared ray cutting property may be reduced, and thus the glass is substantially free from F. Here, the expression of “the glass is substantially free from F” means that when a content of a component element other than F contained in the glass is defined as 100 mass %, and a content of F contained in the glass is indicated in terms of outer percentage, the content of F is less than 3 mass % in terms of outer percentage.

In the glass of the present embodiment, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less in order to improve the weather resistance of the glass. When the content of these components is 5% or less, problems such as reduction in near-infrared ray cutting property, and reduction in transmittance of short wavelength infrared rays are less likely to occur, which is preferable. The content of these components is preferably 4% or less, more preferably 3% or less, further preferably 2% or less, and still further preferably 1% or less.

A thickness of the phosphate glass is 0.3 mm or less and preferably 0.25 mm or less from the viewpoint of ease of optical design when incorporated into a camera module, and the thickness is preferably 0.05 mm or more and more preferably 0.1 mm or more from the viewpoint of device strength and a necessity of obtaining desired optical characteristics. Since the glass of the present embodiment has excellent near-infrared ray absorbing properties, the glass can impart sufficient near-infrared shielding properties to the optical filter even when the glass is thin.

### <Barrier Film>

The optical filter according to the present embodiment includes the barrier films 1 and 2 on or above both main surfaces of the phosphate glass. These barrier films each independently contain one or more selected from TiO₂, Nb₂O₅, Ta₂O₅, and HfO₂. TiO₂, Nb₂O₅, Ta₂O₅, and HfO₂ all have high resistance to moisture, and the presence of the barrier films having such a configuration between the phosphate glass and the dielectric multilayer film can prevent elution of the phosphate glass under an influence of moisture. In addition, from the viewpoint of excellent adhesion to the phosphate glass, the barrier films preferably satisfy such a configuration. For example, a resin material is not preferable as a material of the barrier film 1 and the barrier film 2 from the viewpoint that a property of preventing penetration of moisture is lowered than that of an inorganic material.

The barrier film preferably contains one or more selected from TiO₂, Nb₂O₅, Ta₂O₅, and HfO₂ in a total amount of 80 mol % or more, more preferably 90 mol % or more, further preferably 95 mol % or more, and particularly preferably 100 mol %.

Here, the barrier film may contain one or more selected from TiO₂, Nb₂O₅, Ta₂O₅, and HfO₂ alone in an amount of 80 mol % or more, or may contain two or more materials thereof in a total amount of 80 mol % or more.

In addition, the barrier film may contain a material other than TiO₂, Nb₂O₅, Ta₂O₅, and HfO₂ as long as the resistance to moisture is not impaired. For example, from the viewpoint of adjusting a refractive index of the barrier film, SiO₂ or Al₂O₃ may be contained. In a case where materials other than TiO₂, Nb₂O₅, Ta₂O₅, and HfO₂ are contained, the total content thereof is preferably 20 mol % or less. On the other hand, a layer containing silicon (Si) may reduce the adhesion to a glass substrate, and thus it is preferable that silicon be not contained as much as possible. In addition, from the viewpoint of enhancing water resistance of the optical filter, it is preferable that a material other than an oxide of a metal of aluminum (Al), titanium (Ti), niobium (Nb), tantalum (Ta), or hafnium (Hf) be not contained.

The barrier film 2 and the dielectric multilayer film 2 located in the incident direction of the external light preferably have a physical film thickness satisfying a specific condition. That is, when a film including the barrier film 2 and the dielectric multilayer film 2 is defined as a laminated film 2, X represented by the following formula (1) is preferably 35% or more.

$$X ( \% ) = \{ A / ( B - C ) \} \times 100 \qquad ( 1 )$$

In the formula (1), A (nm) is a total of physical film thicknesses of laminated films 2 having a QWOT of less than 2 and a refractive index of 1.9 or less in the laminated film 2. B (nm) is a thickness of the entire laminated film 2 (total physical film thickness), and C (nm) is a total of thicknesses of layers having a QWOT of 2 or more in the laminated film 2.

Here, the quarter wave optical thickness (QWOT) is an optical film thickness of λ/4 of a wavelength, and is calculated based on the following formula (2).

$$QWOT = ( physical film thickness nm / 550 nm ) \times 4 \times ( refractive index at 550 nm ) \qquad ( 2 )$$

By controlling X, a reflection behavior caused by the provision of the barrier film can be prevented, and an optical filter having better spectral characteristics can be obtained.

When X is 35% or more, for example, the maximum reflectance at a wavelength of 450 nm to 950 nm when a light is incident from the light-absorbing layer side shown in the spectral characteristic (i-5) of the optical filter is likely to be within a desired range, which is preferable. As described above, by controlling the maximum reflectance when a light is incident from the light-absorbing layer side, intrusion of unnecessary light into a sensor can be prevented. In other words, by providing the barrier film 2 and the dielectric multilayer film 2 in which X satisfies 35% or more, a reflectance on the light-absorbing layer side can be controlled.

X is more preferably 50% or more, and particularly preferably 70% or more.

The total physical film thickness of the laminated film 2 is obtained by adding the physical film thickness of the barrier film 2 and the physical film thickness of the dielectric multilayer film 2.

The total physical film thickness of the laminated film 2 having a QWOT of 2 or more is obtained by adding physical film thicknesses of films having a QWOT of 2 or more included in the barrier film 2 and the dielectric multilayer film 2.

The total physical film thickness of the laminated film 2 having a QWOT of less than 2 and a refractive index of 1.9 or less is obtained by adding physical film thicknesses of films having a QWOT of less than 2 and a refractive index of 1.9 or less included in the barrier film 2 and the dielectric multilayer film 2.

A thickness of the barrier film 1 is preferably 10 nm or more, and more preferably 20 nm or more from the viewpoint of enhancing the moisture resistance and the like of the optical filter and improving the reliability.

A thickness of the barrier film 2 is preferably 10 nm or more, and more preferably 20 nm or more from the viewpoint of enhancing the moisture resistance and the like of the optical filter and improving the reliability.

A total physical film thickness of the barrier film 1 and the dielectric multilayer film 1 is preferably 150 nm or more, more preferably 180 nm or more, further preferably 200 nm or more, and particularly preferably 300 nm or more. Such a range is preferable from the viewpoint of improving the water resistance of the optical filter and from the viewpoint of preventing film deformation when a glass surface is altered.

On the other hand, the total physical film thickness of the barrier film 1 and the dielectric multilayer film 1 is preferably 5 μm or less, and more preferably 3 μm or less from the viewpoint of relaxing stress and preventing peeling from the glass. The total physical film thickness of the barrier film 1 and the dielectric multilayer film 1 can be selected according to desired characteristics of the optical filter.

A total physical film thickness of the barrier film 2 and the dielectric multilayer film 2 is preferably 150 nm or more, more preferably 180 nm or more, further preferably 200 nm or more, and particularly preferably 300 nm or more. Such a range is preferable from the viewpoint of improving the water resistance of the optical filter and from the viewpoint of preventing film deformation when a glass surface is altered.

On the other hand, the total physical film thickness of the barrier film 2 and the dielectric multilayer film 2 is preferably 5 μm or less, and more preferably 3 μm or less from the viewpoint of relaxing stress and preventing peeling from the glass. The total physical film thickness of the barrier film 2 and the dielectric multilayer film 2 can be selected according to desired characteristics of the optical filter.

For formation of the barrier film, for example, a vacuum film formation process such as a CVD method, a sputtering method, or a vacuum deposition method, a wet film formation process such as a spraying method or a dipping method, or the like can be used.

In a case where the laminated film 2 has a layer formed of SiO₂, in the laminated film 2, X′ represented by the following formula (3) may be 35% or more. X′ (%) is more preferably 50% or more, and further preferably 70% or more.

$${X}^{′} ( \% ) = \{ {A}^{′} / ( {B}^{′} - {C}^{′} ) \} \times 100 \qquad ( 3 )$$

In the formula (3),
A′ (nm) is a total thickness of SiO₂ layers having a thickness of 180 nm or less in the laminated film 2,
B′ (nm) is a total thickness of the laminated film 2, and
C′ (nm) is a total thickness of SiO₂ layers having a thickness larger than 180 nm of the laminated film 2.

### <Dielectric Multilayer Film>

The optical filter according to the present embodiment includes the dielectric multilayer film 1 on a barrier film 1 side and the dielectric multilayer film 2 on a barrier film 2 side. Although details will be described later, when a film formed of the barrier film 1 and the dielectric multilayer film 1 is set as a laminated film 1 and when a film formed of the barrier film 2 and the dielectric multilayer film 2 is set as the laminated film 2, the laminated film 1 and the laminated film 2 are preferably designed as reflective films (hereinafter, also referred to as “NIR reflective films”) that reflects a part of near-infrared light or near-infrared light antireflection films (hereinafter, also referred to as “NIR antireflection films”). The optical filter according to the present embodiment preferably includes a phosphate glass having excellent absorbing properties of near-infrared light. In this case, even when the laminated film 1 and the laminated film 2 are designed as the NIR reflective films, the optical filter as a whole has an excellent near-infrared light shielding property without enhancing the reflection characteristics in the near-infrared region. By designing these laminated films to prevent the reflection characteristics in the near-infrared region, reduction in transmittance in the visible light region can be avoided, and a shift in spectral characteristics depending on the incident angle is less likely to occur.

The NIR reflective film preferably has, for example, wavelength selectivity of transmitting visible light and mainly reflecting near-infrared light. Specifically, the NIR reflective film preferably has a wavelength band with a width of 100 nm or more in which a reflectance at an incident angle of 5 degrees is 80% or more with respect to light at a wavelength of 750 nm to 1,200 nm. The NIR reflective film may also be appropriately designed to have a specification further reflecting light in a wavelength range other than the near-infrared light, for example, near ultraviolet light.

In order to prevent reflection of visible light even when an incident angle is changed, the NIR antireflection film is preferably a film having a low reflectance in the entire wavelength band rather than a film that reflects light of a specific wavelength.

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band.

The refractive index of the high refractive index material at a wavelength of 500 nm is preferably 1.9 or more and 3.0 or less, more preferably 1.9 or more and 2.8 or less, and further preferably 1.9 or more and 2.6 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among them, TiO₂ is preferable from the viewpoint of reproducibility in film formability and refractive index, stability, and the like.

The medium refractive index material is a material having a refractive index relatively lower than that of the high refractive index material, and the refractive index at a wavelength of 500 nm is preferably 1.5 or more and 2.0 or less, more preferably 1.5 or more and 1.95 or less, and further preferably 1.5 or more and 1.9 or less. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among them, Al₂O₃-based compounds and mixtures of Al₂O₃ and ZrO₂ are preferable from the viewpoint of reproducibility in film formability and refractive index, stability, and the like.

The low refractive index material is a material having a refractive index relatively lower than that of the medium refractive index material, and the refractive index at a wavelength of 500 nm is preferably 1.3 or more and 1.7 or less, more preferably 1.3 or more and 1.65 or less, and further preferably 1.3 or more and 1.6 or less. Examples of the low refractive index material include SiO₂, SiOₓN_{y}, and MgF₂. Other commercially available products thereof include S4F and S5F (mixtures of SiO₂ and AlO₂) manufactured by Canon Optron, Inc. Among them, SiO₂ is preferable from the viewpoint of reproducibility in film formability, stability, economic efficiency, and the like.

In the dielectric multilayer film 1, when a film formed of the barrier film 1 and the dielectric multilayer film 1 is set as the laminated film 1, the laminated film 1 is preferably designed as a reflective film that reflects a part of near-infrared light, and more preferably designed as a reflective film that gently shields light in the near-infrared region.

When the dielectric multilayer film is designed so as to enhance the reflection characteristics in the near-infrared region, a ripple is likely to occur in the visible light region when light with a high incident angle is incident, and the transmittance of visible light is reduced. By designing the laminated film 1 so as not to strongly shield light in the near-infrared region, an optical filter that is hardly affected by the incident angle can be obtained. The light shielding property of the near-infrared region in which light cannot be shielded by the reflection characteristics of the laminated film 1 is complemented by the absorbing properties of the above phosphate glass or a near-infrared ray absorbing dye to be described later, and the present invention has excellent near-infrared ray shielding property as the entire optical filter.

Specifically, an average reflectance at a wavelength of 800 nm to 1,200 nm at an incident angle of 5 degrees is preferably 50% or more and 90% or less.

A film thickness (physical film thickness) of the dielectric multilayer film 1 is preferably 100 nm or more, and more preferably 300 nm or more from the viewpoint of preventing deterioration of a material, and is preferably 5 m or less from the viewpoint of productivity and prevention of a reflection ripple in the visible light region.

The total number of laminated layers of the dielectric multilayer film 1 is preferably 15 or more, more preferably 30 or more, and further preferably 35 or more. However, when the total number of laminated layers is increased, warpage or the like occurs or the film thickness is increased, so that the total number of laminated layers is preferably 100 or less, more preferably 75 or less, and still more preferably 60 or less.

A film thickness (physical film thickness) of the dielectric multilayer film 2 is preferably 100 nm or more, and more preferably 300 nm or more from the viewpoint of preventing deterioration of a material, and is preferably 5 m or less from the viewpoint of productivity and prevention of a reflection ripple in the visible light region.

The total number of laminated layers of the dielectric multilayer film 2 is preferably 1 or more, and more preferably 2 or more. However, when the total number of laminated layers is increased, warpage or the like occurs or the film thickness is increased, so that the total number of laminated layers is preferably 100 or less, more preferably 75 or less, further preferably 50 or less, still further preferably 25 or less, and most preferably 10 or less.

The present filter may include a dielectric multilayer film 3 on at least one outermost surface, preferably on a surface of the light-absorbing layer. From the viewpoint of reducing occurrence of ripples in the visible light region, the dielectric multilayer film 3 is preferably designed as, for example, a near-infrared antireflection film (NTR antireflection film).

The total number of laminated layers of the dielectric multilayer film 3 is preferably 25 or less, more preferably 20 or less, and further preferably 17 or less, and is preferably 3 or more. Tn order to prevent reflection in a visible wavelength band even when the incident angle is changed, a film having a low reflectance in the entire wavelength band is preferable rather than a film that reflects light of a specific wavelength.

A film thickness (physical film thickness) of the dielectric multilayer film 3 is preferably 200 nm to 600 nm as a whole.

For formation of the dielectric multilayer film, for example, a vacuum film formation process such as a CVD method, a sputtering method, or a vacuum deposition method, a wet film formation process such as a spraying method or a dipping method, or the like can be used.

### <Light-Absorbing Layer>

The optical filter according to the present embodiment includes a light-absorbing layer provided on or above the dielectric multilayer film 2. The light-absorbing layer contains a near-infrared ray absorbing dye, and can compensate for absorption in a wavelength region in which light is not shielded by the reflection characteristics of the dielectric multilayer film. The near-infrared ray absorbing dye preferably has a maximum absorption wavelength of 680 nm to 800 nm.

From the viewpoint of being able to widely absorb light in the near-infrared region and preventing reduction in transmittance of visible light, it is preferable to combine two or more kinds of near-infrared ray absorbing dyes having different maximum absorption wavelengths in a region of 680 nm to 800 nm, and it is more preferable to combine one or more kinds of near-infrared ray absorbing dyes having a maximum absorption wavelength of 700 nm or more and less than 740 nm and one or more kinds of near-infrared ray absorbing dyes having a maximum absorption wavelength of 740 nm to 800 nm.

The near-infrared ray absorbing dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The near-infrared ray absorbing dye preferably contains at least one dye selected from a squarylium dye, a phthalocyanine dye, and a cyanine dye. Among these dyes, a squarylium dye and a cyanine dye are preferable from the viewpoint of spectroscopy, and a phthalocyanine dye is preferable from the viewpoint of durability.

The light-absorbing layer is preferably a resin film containing the dye and a resin.

A content of the near-infrared ray absorbing dye in the light-absorbing layer is preferably 0.1 parts by mass to 25 parts by mass, and more preferably 0.3 parts by mass to 15 parts by mass with respect to 100 parts by mass of the resin. In a case where two or more compounds are combined, the above content is a sum of respective compounds.

The light-absorbing layer may include other dyes in addition to the above near-infrared ray absorbing dye. Examples of the other dyes preferably include a dye (UV dye) having a maximum absorption wavelength at 370 nm to 440 nm in the resin. Accordingly, light in a near ultraviolet region can be efficiently shielded.

Examples of the UV dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among them, the merocyanine dye is particularly preferred. These dyes may be used alone, or may be used in combination of two or more kinds thereof.

The resin in the light-absorbing layer is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the light-absorbing layer, one or more kinds of resins selected from a polyimide resin, a polycarbonate resin, a polyester resin, and an acrylic resin are preferable.

In a case where a plurality of compounds are used as the near-infrared ray absorbing dye or other dyes, those compounds may be included in the same light-absorbing layer or may be included in different light-absorbing layers.

The light-absorbing layer can be formed by dissolving or dispersing a dye, a resin or raw material components of the resin, and respective components blended as necessary in a solvent to prepare a coating solution, applying the coating solution on the dielectric multilayer film 2, drying the coating solution, and further curing the coating solution as necessary. Alternatively, the coating solution may be applied to a peelable support used only when the light-absorbing layer is formed, and the light-absorbing layer may be laminated on the dielectric multilayer film 2 later. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. When the coating solution contains a raw material component of the transparent resin, a curing process such as thermal curing or photocuring is further performed.

The light-absorbing layer can also be manufactured into a film shape by extrusion molding. The present filter can be manufactured by laminating the obtained film-shaped absorbing layer on the dielectric multilayer film 2 and integrating those by thermal press fitting or the like.

The light-absorbing layer may be provided in the optical filter by one layer or two or more layers. In a case where the light-absorbing layer is provided by two or more layers, each of the layers may have the same configuration or a different configuration, and two or more layers may be stacked on or above one of the dielectric multilayer films even when the light-absorbing layers are formed on or above each of the dielectric multilayer films.

A thickness of the light-absorbing layer is 10 μm or less and preferably 5 μm or less from the viewpoint of in-plane film thickness distribution and appearance quality in a substrate after coating, and is preferably 0.5 μm or more from the viewpoint of exhibiting desired spectral characteristics at an appropriate dye concentration. In a case where the optical filter has two or more layers of light-absorbing layers, a total thickness of the respective light-absorbing layers is preferably within the above range.

The optical filter according to the present embodiment may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high transmittance of visible light and have light absorbing properties in a wide range of an infrared wavelength region exceeding 1,200 nm, and thus can be used in the case where light-shielding properties of infrared light are required.

### <Imaging Device>

The imaging device according to the present invention preferably includes the optical filter according to the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the present filter which is excellent in transmittance of visible light, has shielding properties of specific near-infrared light, and has a spectral curve hardly shifted even at a high incident angle, an imaging device excellent in color reproducibility even for light at a high incident angle can be obtained.

When the optical filter is to be mounted on the imaging device, it is usually preferable that the dielectric multilayer film 1 be on a lens side (external light incident side) and the dielectric multilayer film 2 be on a sensor side.

As described above, the present description discloses the following optical filter and the like.
[1] An optical filter including:
a phosphate glass;
a dielectric multilayer film 1 and a dielectric multilayer film 2 provided on both surface sides of the phosphate glass;
a barrier film 1 provided between the phosphate glass and the dielectric multilayer film 1;
a barrier film 2 provided between the phosphate glass and the dielectric multilayer film 2; and
a light-absorbing layer provided on or above the dielectric multilayer film 2, in which
the phosphate glass has near-infrared ray absorbing properties, is substantially free from fluorine atoms, and has a thickness of 0.3 mm or less,
the light-absorbing layer includes a near-infrared ray absorbing dye,
the barrier film 1 and the barrier film 2 each independently include one or more selected from TiO₂, Nb₂O₅, Ta₂O₅, and HfO₂, and
the optical filter satisfies all of the following spectral characteristics (i-1) to (i-5):
(i-1) an average transmittance at a wavelength of 440 nm to 500 nm is 75% or more at an incident angle of 0 degrees and 60% or more at an incident angle of 60 degrees,
(i-2) an average transmittance at a wavelength of 750 nm to 1,000 nm is 2% or less at an incident angle of 0 degrees and 2% or less at an incident angle of 60 degrees,
(i-3) in a spectral transmittance curve at an incident angle of 0 degrees, a wavelength IR 10_{(0 deg)} at which a transmittance is 10% is in a range of 600 nm to 700 nm,
(i-4) an absolute value of a difference between the wavelength IR 10_{(0 deg)} at which the transmittance is 10% in the range of 600 nm to 700 nm in the spectral transmittance curve at an incident angle of 0 degrees and a wavelength IR 10_{(60 deg)} at which a transmittance is 10% in the range of 600 nm to 700 nm in a spectral transmittance curve at an incident angle of 60 degrees is 15 nm or less, and
(i-5) a transmittance at a wavelength of 1,100 nm is 5% or less at an incident angle of 0 degrees and 5% or less at an incident angle of 60 degrees.
[2] The optical filter according to [1], in which
the optical filter satisfies the following spectral characteristic (i-6):
(i-6) a maximum transmittance at a wavelength of 750 nm to 1,000 nm is 2% or less at an incident angle of 0 degrees and 2% or less at an incident angle of 60 degrees.
[3] The optical filter according to [1] or [2], in which
the phosphate glass has a thickness of 0.25 mm or less, and
the optical filter satisfies the following spectral characteristic (i-7):
(i-7) a transmittance at a wavelength of 1,100 nm is 2% or less at an incident angle of 0 degrees.
[4] The optical filter according to any of [1] to [3], in which
the phosphate glass contains 12% or more of CuO in terms of mol % based on oxides.
[5] The optical filter according to [4], in which
the phosphate glass contains 13% or more of Al₂O₃ in terms of mol % based on oxides.
[6] The optical filter according to [4] or [5], in which
the phosphate glass contains 0.1% to 5% of MoO₃ in terms of mol % based on oxides.
[7] The optical filter according to any of [1] to [6], in which
the phosphate glass has, in terms of a plate thickness of 0.25 mm,
an average transmittance of 70% or more at a wavelength of 440 nm to 500 nm,
a transmittance of 5.5% or less at a wavelength of 1,200 nm,
a transmittance of 1.0% or less at a wavelength of 1,000 nm, and
a transmittance of 1.5% or less at a wavelength of 800 nm.
[8] The optical filter according to any of [1] to [7], in which
the barrier film 1 and the barrier film 2 contain TiO₂.
[9] The optical filter according to any of [1] to [8], in which
each of the barrier film 1 and the barrier film 2 has a thickness of 10 nm or more.
[10] The optical filter according to any of [1] to [9], in which
the dielectric multilayer film 1 has a thickness of 1.0 μm or more.
[11] The optical filter according to any of [1] to [10], in which
the light-absorbing layer includes:
one or more near-infrared ray absorbing dyes having a maximum absorption wavelength in a range of 700 nm or more and less than 740 nm; and
one or more near-infrared ray absorbing dyes having a maximum absorption wavelength in a range of 740 nm or more and 800 nm or less.
[12] An imaging device including the optical filter according to any of [1] to [11].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of an optical filter).

Dyes used in respective examples are as follows.
Compound 1 (cyanine compound): synthesized based on Dyes and pigments 73 (2007) 344-352.
Compound 2 (merocyanine compound): synthesized based on the description of German Patent No. 10109243.
Compound 3 (squarylium compound): synthesized based on WO2017/135359.
Compound 4 (squarylium compound): synthesized based on WO2014/088063 and WO2016/133099.

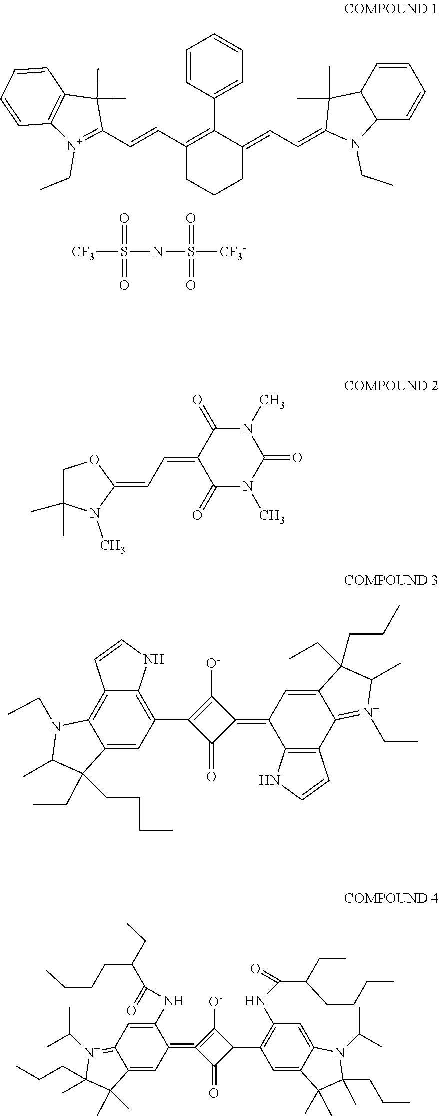

The compounds 1, 3, and 4 are near-infrared ray absorbing dyes (NIR dyes), and the compound 2 is a near ultraviolet absorbing dye (UV dye). The maximum absorption wavelength of each dye is shown in Table 5 below.

### <Spectral Characteristics of Glass>

The following glass was prepared.

As a phosphate glass or a fluorophosphate glass, raw materials were weighed and mixed so as to have contents shown in Table 5 in terms of mol % based on oxides, placed in a crucible having an internal volume of about 400 mL, and melted for 2 hours. Thereafter, the mixture was refined, stirred, and cast into a rectangular mold of 100 mm length×80 mm width×20 mm height that was preheated to about 300° C. to 500° C., and then slowly cooled at about 1° C./min to obtain a glass of a plate-shaped sample having both surfaces optically polished to a sheet thickness of 0.25 mm.

Spectral characteristics of each glass are shown in Table 1 below.

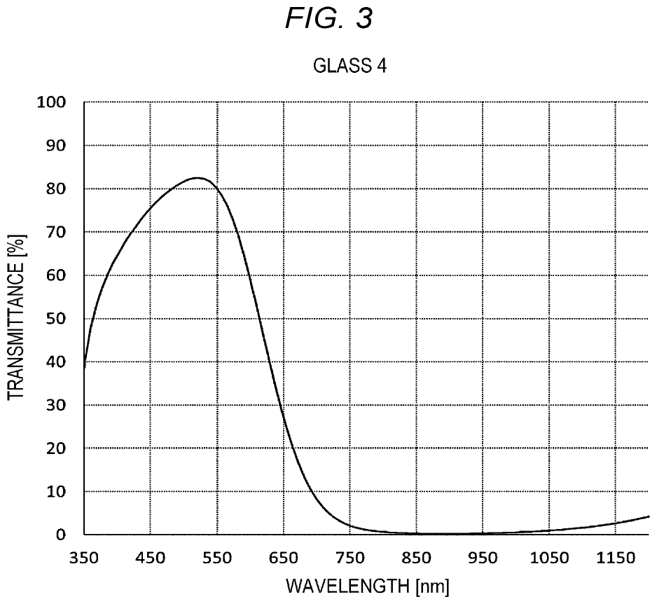

In addition, a spectral transmittance curve of a glass 4 is illustrated in FIG. 3.

TABLE 1

| | | Glass 1 | Glass 2 | Glass 3 | Glass 4 | Glass 5 | Glass 6 | Glass 7 | Glass 8 |
|---|---|---|---|---|---|---|---|---|---|
| Glass | Glass type | phosphate | phosphate | phosphate | phosphate | phosphate | phosphate | phosphate | Fluoro- |
| | | | | | | | | | phosphate |
| | Plate | 0.25 | 0.25 | 0.25 | 0.25 | 0.25 | 0.25 | 0.25 | 0.25 |
| | thickness [mm] | | | | | | | | |
| Glass | P₂O₅ | 57.54 | 57.69 | 57.69 | 57.69 | 57.69 | 57.40 | 57.69 | 25.41 |
| composition | Al₂O₃ | 13.24 | 15.24 | 16.22 | 17.20 | 18.19 | 17.12 | 13.27 | 5.35 |
| [mol %] | LiO₂ | — | — | — | — | — | — | — | 14.16 |
| | Na₂O | 6.07 | 6.08 | 6.08 | 6.08 | 6.08 | 6.05 | 6.08 | — |
| | K₂O | 8.49 | 6.55 | 5.56 | 4.58 | 4.58 | 5.54 | 11.46 | — |
| | ZnO | — | — | — | — | — | — | — | — |
| | SnO₂ | — | — | — | — | — | — | — | — |
| | MoO₃ | 0.25 | — | — | — | — | 0.49 | — | — |
| | MgO | — | — | — | — | — | — | — | 3.85 |
| | CaO | — | — | — | — | — | — | — | 5.23 |
| | SrO | — | — | — | — | — | — | — | 6.50 |
| | BaO | — | — | — | — | — | — | — | 6.75 |
| | CuO | 14.41 | 14.45 | 14.45 | 14.45 | 13.47 | 13.4 | 11.50 | 4.89 |
| | F | — | — | — | — | — | — | — | 27.87 |
| Total | | 100.0 | 100.0 | 100.0 | 100.0 | 100.0 | 100.0 | 100.0 | 100.0 |
| Spectral | 0 deg incident light | 88.40 | 83.01 | 80.85 | 78.28 | 76.12 | 83.72 | 89.18 | 87.89 |
| characteristics | Average transmittance | | | | | | | | |
| of glass | at wavelength of | | | | | | | | |
| | 440 nm to 500 nm [%] | | | | | | | | |
| | 0 deg incident light | 3.48 | 3.82 | 3.85 | 4.26 | 5.38 | 5.11 | 6.15 | 20.26 |
| | Transmittance at | | | | | | | | |
| | wavelength | | | | | | | | |
| | of 1,200 nm [%] | | | | | | | | |
| | 0 deg incident light | 0.46 | 0.51 | 0.51 | 0.59 | 0.85 | 0.79 | 1.22 | 5.34 |
| | Transmittance at | | | | | | | | |
| | wavelength | | | | | | | | |
| | of 1,000 nm [%] | | | | | | | | |
| | 0 deg incident light | 0.67 | 0.69 | 0.65 | 0.68 | 0.94 | 0.83 | 1.89 | 2.40 |
| | Transmittance at | | | | | | | | |
| | wavelength | | | | | | | | |
| | of 800 nm [%] | | | | | | | | |

According to the above results, in glasses 1 to 6, by containing 12% or more of CuO, near-infrared absorbing properties could be improved.

In addition, in the glass 1 and the glass 6, by containing MoO₃, the transmittance of visible light could be improved.

### <Reliability Test 1 of Glass>

A test piece having a length of 5 mm, a width of 5 mm, and a thickness shown in Table 2 of any of glasses 4 to 7 manufactured as described above was prepared, and materials shown in Table 2 below were laminated on both main surfaces by vapor deposition to form barrier films.

The glass substrate with the barrier film was subjected to a high-temperature and high-humidity test under the following conditions.

After the glass substrate with the barrier film was allowed to stand under an environment of a temperature of 85° C. and a relative humidity of 85% for a time shown in Table 2, an end surface was observed with a metal microscope at a magnification of 200 from a main surface side to evaluate the degree of deterioration. A distance from the end surface of a most deteriorated portion was measured and evaluated based on the following criteria. C or better is regarded as acceptable.
A: deterioration of end surface was less than 100 μm
B: deterioration of end surface was 100 μm or more and less than 150 μm
C: deterioration of end surface was 150 μm or more and less than 200 μm
D: deterioration of end surface was 200 μm or more

Evaluation results are shown in Table 2 below.

Examples 1-1 to 1-5 are reference inventive examples, and Examples 1-6 to 1-10 are reference comparative examples.

TABLE 2

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple | ple | ple | ple | ple | ple | ple | ple | ple | ple |
| | | | 1-1 | 1-2 | 1-3 | 1-4 | 1-5 | 1-6 | 1-7 | 1-8 | 1-9 | 1-10 |
| Sample | Barrier | Film | TiO₂ | Ta₂O₅ | TiO₂ | TiO₂ | TiO₂ | Al₂O₃ | SiO₂ | Al₂O₃ | — | — |
| conditions | film | material | | | | | | | | | | |
| | | Thickness | 143 | 143 | 143 | 143 | 143 | 143 | 143 | 143 | — | — |
| | | [nm] | | | | | | | | | | |
| | Glass | Type | Glass 7 | Glass 7 | Glass 4 | Glass 6 | Glass 5 | Glass 4 | Glass 7 | Glass 7 | Glass 7 | Glass 4 |
| | | Thickness | 0.29 | 0.29 | 0.2 | 0.2 | 0.2 | 0.2 | 0.29 | 0.29 | 0.29 | 0.2 |
| | | [mm] | | | | | | | | | | |
| | Barrier | Film | TiO₂ | Ta₂O₅ | TiO₂ | TiO₂ | TiO₂ | Al₂O₃ | SiO₂ | Al₂O₃ | — | — |
| | film | material | | | | | | | | | | |
| | | Thickness | 143 | 143 | 143 | 143 | 143 | 143 | 143 | 143 | — | — |
| | | [nm] | | | | | | | | | | |

| | | | | | | | | | | | |
|---|---|---|---|---|---|---|---|---|---|---|---|
| Results of | Test time | | | | | | | | | | |
| reliability | 100 hours | A | A | A | A | A | D | D | D | D | D |
| test | 250 hours | B | C | A | A | A | D | D | D | D | D |

From the above results, it is understood that a barrier film made of titania or tantalum has excellent durability, and particularly, titania is preferable. On the other hand, in a barrier film made of alumina or silica, deterioration of the end surface was confirmed, and durability was not obtained.

### <Reliability Test 2 of Glass>

Test pieces having a length of 5 mm, a width of 5 mm, and a thickness of 0.3 mm of the glasses 1 to 7 manufactured as described above were prepared, and TiO₂ was laminated on both main surfaces by vapor deposition to form barrier films. Further, SiO₂ and TiO₂ were alternately laminated on a surface of each barrier film by vapor deposition to form a dielectric multilayer film A or B having a configuration shown in Table 4. A film number 1 is a layer in contact with the barrier film.

With respect to the obtained test piece, the degree of deterioration of the end surface was evaluated by the same method and reference as in the reliability test 1 of glass.

Evaluation results are shown in Table 3 below.

Examples 1-11 to 1-18 are reference inventive examples.

TABLE 3

| | | | Example | Example | Example | Example | Example | Example | Example | Example |
|---|---|---|---|---|---|---|---|---|---|---|
| | | | 1-11 | 1-12 | 1-13 | 1-14 | 1-15 | 1-16 | 1-17 | 1-18 |
| Sample | Dielectric | Type | Film A | Film A | Film A | Film A | Film A | Film A | Film A | Film B |
| conditions | multilayer | | | | | | | | | |
| | film | | | | | | | | | |
| | Barrier | Film | TiO₂ | TiO₂ | TiO₂ | TiO₂ | TiO₂ | TiO₂ | TiO₂ | TiO₂ |
| | film | material | | | | | | | | |
| | | Thickness | 11.49 | 11.49 | 11.49 | 11.49 | 11.49 | 11.49 | 11.49 | 11.49 |
| | | [nm] | | | | | | | | |
| | Glass | Type | Glass 1 | Glass 2 | Glass 3 | Glass 4 | Glass 5 | Glass 6 | Glass 7 | Glass 7 |
| | | Thickness | 0.3 | 0.3 | 0.3 | 0.3 | 0.3 | 0.3 | 0.3 | 0.3 |
| | | [mm] | | | | | | | | |
| | Barrier | Film | TiO₂ | TiO₂ | TiO₂ | TiO₂ | TiO₂ | TiO₂ | TiO₂ | TiO₂ |
| | film | material | | | | | | | | |
| | | Thickness | 11.49 | 11.49 | 11.49 | 11.49 | 11.49 | 11.49 | 11.49 | 11.49 |
| | | [nm] | | | | | | | | |
| | Dielectric | Type | Film A | Film A | Film A | Film A | Film A | Film A | Film A | Film B |
| | multilayer | | | | | | | | | |
| | film | | | | | | | | | |

| Thicknesses of dielectric multilayer | | 1,645 | 1,645 | 1,645 | 1,645 | 1,645 | 1,645 | 1,645 | 645 |
|---|---|---|---|---|---|---|---|---|---|
| film + barrier film [nm] | | | | | | | | | |
| Results of | Test time | | | | | | | | |
| reliability test | 100 hours | A | A | A | A | A | A | A | A |
| | 250 hours | B | B | A | A | A | A | A | B |

TABLE 4

| Dielectric multilayer film A | | | Dielectric multilayer film B | | |
|---|---|---|---|---|---|
| | | Physical film | | | Physical film |
| Film | Film | thickness | Film | Film | thickness |
| number | material | [nm] | number | material | [nm] |
| Barrier film side | | | Barrier film side | | |
| 1 | SiO₂ | 57.88 | 1 | SiO₂ | 57.88 |
| 2 | TiO₂ | 23.98 | 2 | TiO₂ | 23.98 |
| 3 | SiO₂ | 60.37 | 3 | SiO₂ | 60.37 |
| 4 | TiO₂ | 20.17 | 4 | TiO₂ | 20.17 |
| 5 | SiO₂ | 89.86 | 5 | SiO₂ | 89.86 |
| 6 | TiO₂ | 12.96 | 6 | TiO₂ | 12.96 |
| 7 | SiO₂ | 80.19 | 7 | SiO₂ | 80.19 |
| 8 | TiO₂ | 26.77 | 8 | TiO₂ | 26.77 |
| 9 | SiO₂ | 28.54 | 9 | SiO₂ | 28.54 |
| 10 | TiO₂ | 80.07 | 10 | TiO₂ | 80.07 |
| 11 | SiO₂ | 13.91 | 11 | SiO₂ | 13.91 |
| 12 | TiO₂ | 31.37 | 12 | TiO₂ | 31.37 |
| 13 | SiO₂ | 1,107.65 | 13 | SiO₂ | 107.65 |

| | | | |
|---|---|---|---|
| Entire physical film | 1,668.28 | Entire physical film | 633.72 |
| thickness \|nm\| | | thickness \|nm\| | |

According to results of the above Examples 1-11 to 1-18, the durability of the barrier film could be confirmed in any of the phosphate glasses.

In addition, according to comparison between Examples 1-17 and 1-18, it could be confirmed that the larger a total film thickness of the barrier film and the dielectric multilayer film, the higher the durability.

### <Spectral Characteristics of Light-Absorbing Layer 1>

The dyes of the compounds 1 to 4 were dissolved in a polyimide resin C-3G30G manufactured by Mitsubishi Gas Chemical Company, Inc., mixed at a concentration shown in Table 5 below, and stirred and dissolved at 50° C. for 2 hours to obtain a coating solution. The obtained coating solution was applied onto an alkaline glass (D263 glass, manufactured by SCHOTT, thickness: 0.2 mm) by a spin coating method to form a light-absorbing layer having a film thickness of 1.0 μm.

With respect to the obtained light-absorbing layer, a spectral transmittance curve and a spectral reflectance curve in a wavelength range of 350 nm to 1,200 nm were measured using the ultraviolet-visible spectrophotometer.

Results are shown in Table 5 below.

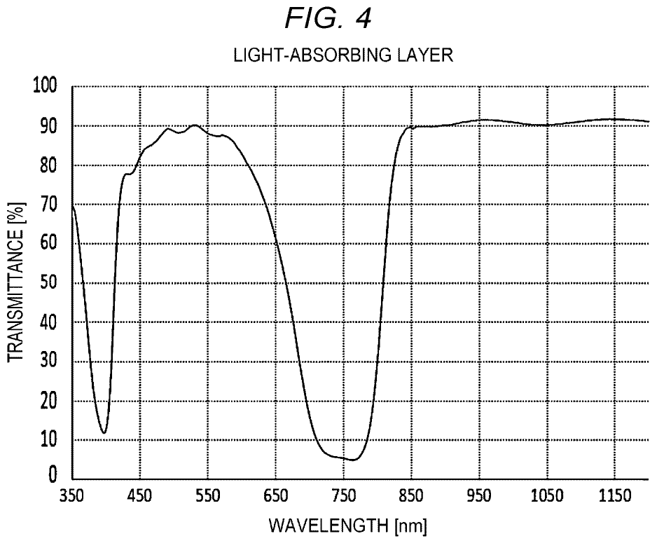

The spectral transmittance curve of the light-absorbing layer is illustrated in FIG. 4.

TABLE 5

| | | Light-absorbing |
|---|---|---|
| | | layer 1 |
| Dye addition | Compound 1 (λMAX: 772 nm) | 4.16 |
| amount (mass %) | Compound 2 (λMAX: 397 nm) | 3.24 |
| | Compound 3 (λMAX: 752 nm) | 1.17 |
| | Compound 4 (λMAX: 722 nm) | 2.21 |
| | Total | 10.8 |
| Spectral character- | 0 deg incident light | 86.88 |
| istics of light- | Average transmittance at | |
| absorbing layer | wavelength of 440 nm to | |
| | 600 nm [%] | |
| | 0 deg incident light | 665 |
| | Wavelength at which | |
| | transmittance at | |
| | wavelength of 500 nm | |
| | to 700 nm is 50% [nm] | |
| | 0 deg incident light | 60 |
| | Absolute value of difference | |
| | between wavelength at which | |
| | transmittance is 20% and | |
| | wavelength at which transmit- | |
| | tance is 70% at wavelength | |
| | of 500 nm to 700 nm [nm] | |
| | 0 deg incident light | 9.02 |
| | Average transmittance at | |
| | wavelength of 700 nm to | |
| | 800 nm [%} | |

### Example 2-1: Spectral Characteristics of Optical Filter

A barrier film 1 and a barrier film 2 were each formed by laminating TiO₂ on both main surfaces of the glass 1 (phosphate glass) having a plate thickness of 0.3 mm by vapor deposition with the same composition as in Example 1-1.

A dielectric multilayer film 1A having a configuration shown in Table 6 was formed by alternately laminating SiO₂ and TiO₂ on a surface of the barrier film 1 by vapor deposition.

A film number 1 is a layer in contact with the light-absorbing layer.

A dielectric multilayer film 2A having a configuration shown in Table 6 was formed by alternately laminating SiO₂ and TiO₂ on a surface of the barrier film 2 by vapor deposition.

A film number 1 is a layer in contact with the light-absorbing layer.

With the same composition as that of the light-absorbing layer 1, a resin solution was applied to a surface of the barrier film 2, and an organic solvent was removed by sufficiently heating to form a light-absorbing layer having a thickness of 1.0 μm.

A dielectric multilayer film 3A (antireflection film) was formed by alternately laminating SiO₂ and TiO₂ on a surface of the light-absorbing layer by vapor deposition.

Thus, an optical filter 2-1 was manufactured.

### Example 2-2

An optical Filter 2-2 was manufactured in the same manner as in Example 2-1 except that the glass 4 (phosphate glass) was used instead of the glass 1.

### Example 2-3

An optical filter 2-3 was manufactured in the same manner as in Example 2-2 except that a dielectric multilayer film 1B having a configuration shown in Table 6 was formed instead of the dielectric multilayer film 1A.

### Example 2-4

An optical Filter 2-4 was manufactured in the same manner as in Example 2-1 except that the glass 7 (phosphate glass) was used instead of the glass 1.

### Example 2-5

An optical Filter 2-5 was manufactured in the same manner as in Example 2-1 except that the glass 8 (fluorophosphate glass) was used instead of the glass 1.

### Example 2-6

An optical Filter 2-6 was manufactured in the same manner as in Example 2-1 except that a glass 1 (phosphate glass) having a plate thickness of 0.25 mm was used instead of the glass 1 (phosphate glass) having a plate thickness of 0.3 mm.

### Example 2-7

An optical Filter 2-7 was manufactured in the same manner as in Example 2-2 except that a glass 4 (phosphate glass) having a plate thickness of 0.25 mm was used instead of the glass 4 (phosphate glass) having a plate thickness of 0.3 mm.

### Example 2-8

An optical Filter 2-8 was manufactured in the same manner as in Example 2-3 except that the glass 4 (phosphate glass) having a plate thickness of 0.25 mm was used instead of the glass 4 (phosphate glass) having a plate thickness of 0.3 mm.

### Example 2-9

An optical Filter 2-9 was manufactured in the same manner as in Example 2-4 except that a glass 7 (phosphate glass) having a plate thickness of 0.25 mm was used instead of the glass 7 (phosphate glass) having a plate thickness of 0.3 mm.

### Example 2-10

An optical Filter 2-10 was manufactured in the same manner as in Example 2-5 except that a glass 8 (fluorophosphate glass) having a plate thickness of 0.25 mm was used instead of the glass 8 (fluorophosphate glass) having a plate thickness of 0.3 mm.

TABLE 6

| Dielectric multi- | | | Dielectric multi- | | | Dielectric multi- | | | | Dielectric multi- | | |
|---|---|---|---|---|---|---|---|---|---|---|---|---|
| layer film 1A | | | layer film 1B | | | layer film 2A | | | | layer film 3A | | |
| | | Physical | | | Physical | | | Physical | | | | Physical |
| | | film | | | film | | | film | | | | film |
| Film | Film | thickness | Film | Film | thickness | Film | Film | thickness | | Film | Film | thickness |
| number | material | [nm] | number | material | [nm] | number | material | [nm] | QWOT | number | material | [nm] |
| Barrier film 1 side | | | Barrier film 1 side | | | Light-absorbing layer side | | | | Air side | | |
| 1 | SiO₂ | 56.46 | 1 | SiO₂ | 35.91 | 5 | SiO₂ | 2,000 | 21.34 | 8 | SiO₂ | 105.16 |
| 2 | TiO₂ | 19.47 | 2 | TiO₂ | 122.19 | 4 | TiO₂ | 10 | 0.18 | 7 | TiO₂ | 29.12 |
| 3 | SiO₂ | 61.02 | 3 | SiO₂ | 54.43 | 3 | SiO₂ | 58.15 | 0.62 | 6 | SiO₂ | 13.38 |
| 4 | TiO₂ | 10 | 4 | TiO₂ | 16.5 | 2 | TiO₂ | 20.65 | 0.37 | 5 | TiO₂ | 77.82 |
| 5 | SiO₂ | 2,000 | 5 | SiO₂ | 56.34 | 1 | SiO₂ | 53.25 | 0.57 | 4 | SiO₂ | 25.88 |
| 6 | TiO₂ | 10 | 6 | TiO₂ | 114.35 | Barrier film 2 side | | | | 3 | TiO₂ | 24.2 |
| 7 | SiO₂ | 71.06 | 7 | SiO₂ | 56.99 | | | | | 2 | SiO₂ | 63.49 |
| 8 | TiO₂ | 17.37 | 8 | TiO₂ | 13.78 | | | | | 1 | TiO₂ | 9.11 |
| 9 | SiO₂ | 79.72 | 9 | SiO₂ | 56.98 | | | | | Light-absorbing layer side | | |
| 10 | TiO₂ | 13.04 | 10 | TiO₂ | 105.53 | | | | | | | |
| 11 | SiO₂ | 108.92 | 11 | SiO₂ | 50.31 | | | | | | | |
| 12 | TiO₂ | 11.45 | 12 | TiO₂ | 13.84 | | | | | | | |
| 13 | SiO₂ | 82 | 13 | SiO₂ | 53.62 | | | | | | | |
| 14 | TiO₂ | 27.13 | 14 | TiO₂ | 104.72 | | | | | | | |
| 15 | SiO₂ | 34.26 | 15 | SiO₂ | 56.61 | | | | | | | |
| 16 | TiO₂ | 59.11 | 16 | TiO₂ | 13.45 | | | | | | | |
| 17 | SiO₂ | 23.31 | 17 | SiO₂ | 54.46 | | | | | | | |
| 18 | TiO₂ | 32.71 | 18 | TiO₂ | 106.8 | | | | | | | |
| 19 | SiO₂ | 113.9 | 19 | SiO₂ | 57.43 | | | | | | | |

| Air side | 20 | TiO₂ | 14.28 |
|---|---|---|---|
| | 21 | SiO₂ | 58.28 |
| | 22 | TiO₂ | 114.06 |
| | 23 | SiO₂ | 62.37 |
| | 24 | TiO₂ | 13.85 |
| | 25 | SiO₂ | 61.9 |
| | 26 | TiO₂ | 118.14 |
| | 27 | SiO₂ | 63.3 |
| | 28 | TiO₂ | 13.92 |
| | 29 | SiO₂ | 60.87 |
| | 30 | TiO₂ | 121.02 |
| | 31 | SiO₂ | 53.44 |
| | 32 | TiO₂ | 20 |
| | 33 | SiO₂ | 49.62 |
| | 34 | TiO₂ | 127.66 |
| | 35 | SiO₂ | 40.8 |
| | 36 | TiO₂ | 27.53 |
| | 37 | SiO₂ | 40.05 |
| | 38 | TiO₂ | 130.36 |
| | 39 | SiO₂ | 44.52 |
| | 40 | TiO₂ | 22.59 |
| | 41 | SiO₂ | 47.67 |
| | 42 | TiO₂ | 122.93 |
| | 43 | SiO₂ | 52.55 |
| | 44 | TiO₂ | 18.7 |
| | 45 | SiO₂ | 48.14 |
| | 46 | TiO₂ | 111.04 |
| | 47 | SiO₂ | 88.3 |

Air side

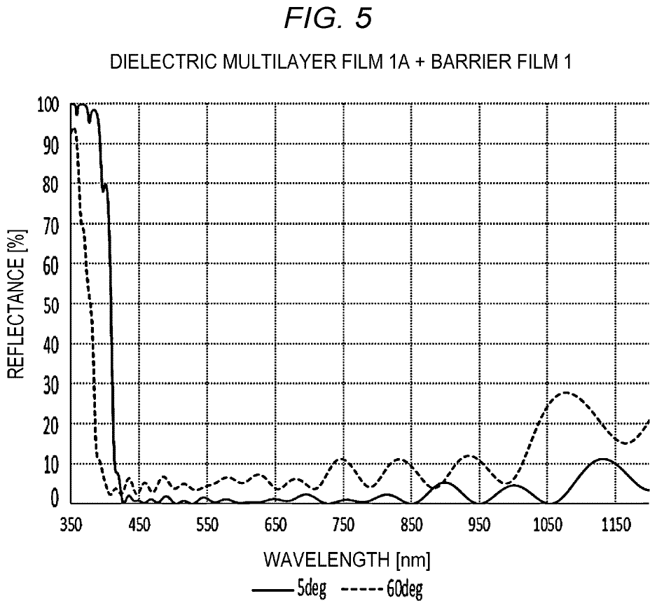

FIG. 5 illustrates spectral reflectance curves of a laminated film including the dielectric multilayer film 1A and the barrier film 1.

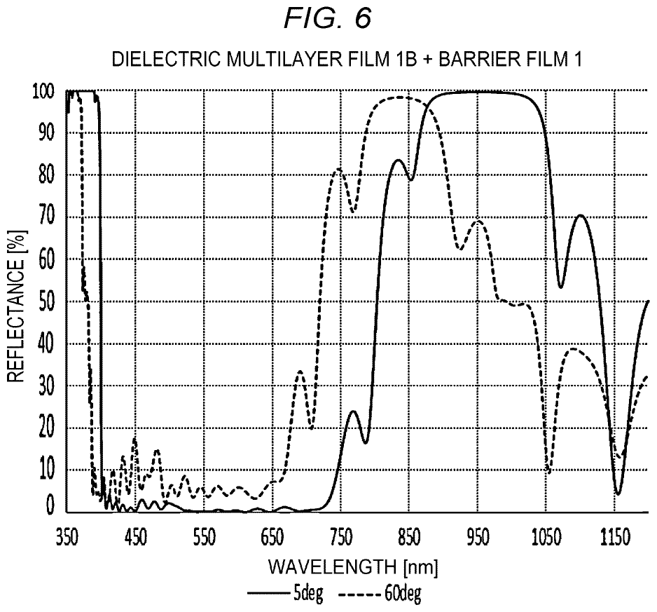

FIG. 6 illustrates spectral reflectance curves of a laminated film including the dielectric multilayer film 1B and the barrier film 1.

Reflection characteristics of the laminated films mainly indicate reflection characteristics of the dielectric multilayer film 1A or the dielectric multilayer film 1B. From this, it is understood that the dielectric multilayer film 1A and the dielectric multilayer film 1B are designed such that the reflectance in the visible light region is kept low.

With respect to the respective optical filters obtained as described above, spectral transmittance curves at an incident angle of 0 degrees and an incident angle of 60 degrees, and spectral reflectance curves at an incident angle of 5 degrees and an incident angle of 60 degrees in a wavelength range of 350 nm to 1,200 nm were measured using the ultraviolet-visible spectrophotometer.

In addition, the degree of deterioration of the end surface was evaluated by the same method and reference as in the reliability test 1 of glass.

Respective characteristics shown in Table 7 and Table 8 below were calculated based on the obtained data of the spectral characteristics.

A method of calculating X in the laminated film 2 will be specifically described by taking the laminated film 2 formed of the dielectric multilayer film 2A and the barrier film 2 as an example. Here, the refractive index of SiO₂ is 1.9 or less, and the refractive index of TiO₂ exceeds 1.9.

A total physical film thickness of the laminated film 2 having a QWOT of less than 2 and a refractive index of 1.9 or less can be calculated based on a sum of a physical film thickness of a SiO₂ film of film number 1 constituting the dielectric multilayer film 2A and a physical film thickness of a SiO₂ film of film number 3 shown in Table 6.

The total physical film thickness of the laminated film 2 can be calculated based on a sum of a physical film thickness of the entire dielectric multilayer film 2A and a physical film thickness of the barrier film 2.

A total physical film thickness of the laminated film 2 having a QWOT of 2 or more corresponds to a physical film thickness of a SiO₂ film of film number 5 constituting the dielectric multilayer film 2A shown in Table 6.

Thus, X was calculated.

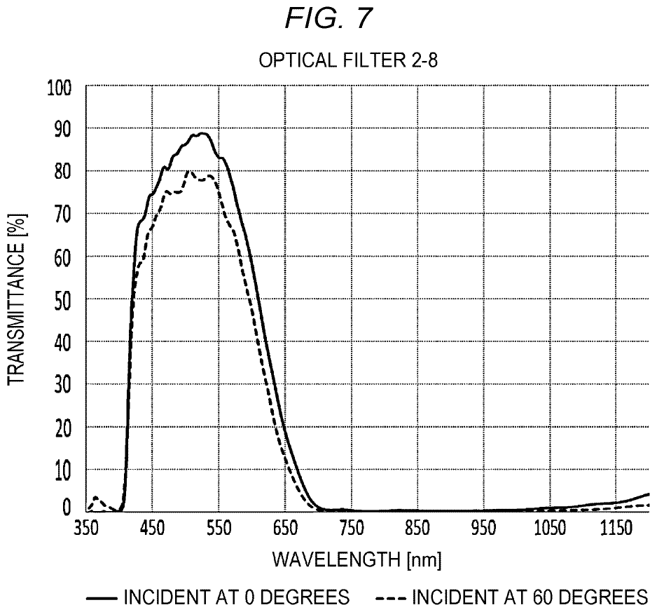

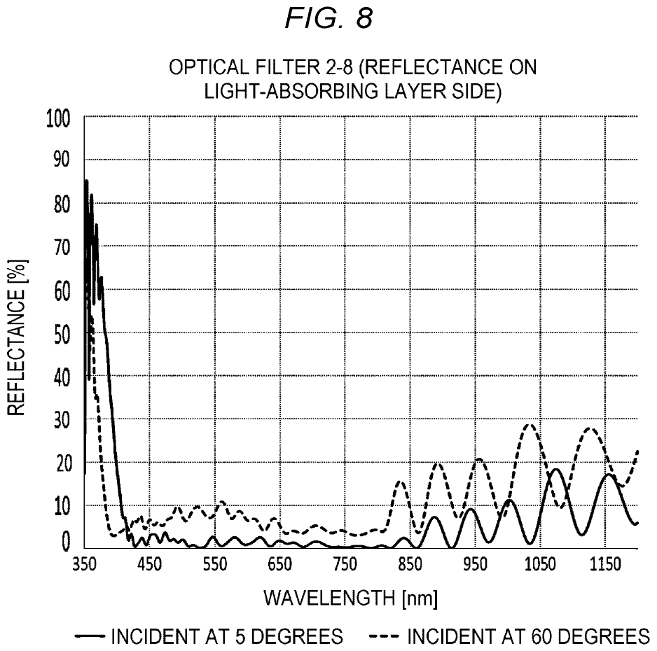

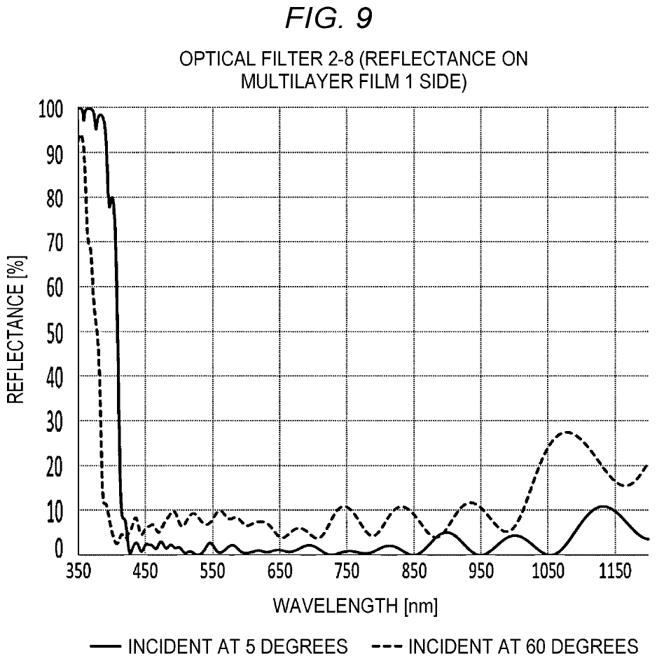

FIG. 7 illustrates spectral transmittance curves of the optical filter of Example 2-8, FIG. 8 illustrates spectral reflectance curves (on light-absorbing layer side), and FIG. 9 illustrates spectral reflectance curves (on multilayer film 1 side).

Examples 2-1 to 2-4 and 2-6 to 2-9 are inventive examples, and Examples 2-5 and 2-10 are comparative examples.

TABLE 7

| | | | Example | Example | Example | Example | Example |
|---|---|---|---|---|---|---|---|
| | | | 2-1 | 2-2 | 2-3 | 2-4 | 2-5 |
| Configuration | Dielectric | Type | 3A | 3A | 3A | 3A | 3A |
| of optical | multilayer | Film | TiO₂/SiO₂ | TiO₂/SiO₂ | TiO₂/SiO₂ | TiO₂/SiO₂ | TiO₂/SiO₂ |
| filter | film 3 | configuration | 8 layers | 8 layers | 8 layers | 8 layers | 8 layers |
| | | Total film | 348 | 348 | 348 | 348 | 348 |
| | | thickness | | | | | |
| | | [nm] | | | | | |
| | Light-absorbing layer | | 1 | 1 | 1 | 1 | 1 |
| | Dielectric | Type | 2A | 2A | 2A | 2A | 2A |
| | multilayer | Film | TiO₂/SiO₂ | TiO₂/SiO₂ | TiO₂/SiO₂ | TiO₂/SiO₂ | TiO₂/SiO₂ |
| | film 2 | configuration | 5 layers | 5 layers | 5 layers | 5 layers | 5 layers |
| | | Total film | 2,142 | 2,142 | 2,142 | 2,142 | 2,142 |
| | | thickness | | | | | |
| | | [nm] | | | | | |
| | Barrier film 2 | Film material | TiO₂ | TiO₂ | TiO₂ | TiO₂ | TiO₂ |
| | | Thickness | 12 | 12 | 12 | 12 | 12 |
| | | [nm] | | | | | |
| | Glass | Type | Glass 1 | Glass 4 | Glass 4 | Glass 7 | Glass 8 |
| | | Thickness | 0.3 | 0.3 | 0.3 | 0.3 | 0.3 |
| | | [mm] | | | | | |
| | Barrier film 1 | Film material | TiO₂ | TiO₂ | TiO₂ | TiO₂ | TiO₂ |
| | | Thickness | 12 | 12 | 12 | 12 | 12 |
| | | [nm] | | | | | |
| | Dielectric | Type | 1A | 1A | 1B | 1A | 1A |
| | multilayer | Film | TiO₂/SiO₂ | TiO₂/SiO₂ | TiO₂/SiO₂ | TiO₂/SiO₂ | TiO₂/SiO₂ |
| | film 1 | configuration | 19 layers | 19 layers | 47 layers | 19 layers | 39 layers |
| | | Total film | 2,843 | 2,843 | 2,892 | 2,843 | 2,843 |
| | | thickness | | | | | |
| | | [nm] | | | | | |

| Results of reliability test: 100 hours | | A | No Data | No Data | A | A |
|---|---|---|---|---|---|---|
| Results of reliability test: 250 hours | | A | No Data | No Data | A | A |
| Spectral | Average transmittance at | 89.5 | 77.5 | 76.2 | 90.1 | 89.4 |
| characteristics | wavelength of 440 nm to | | | | | |
| | 500 nm at 0 deg [%] | | | | | |
| | Average transmittance at | 82.7 | 69.5 | 65.6 | 83.4 | 82.7 |
| | wavelength of 440 nm to | | | | | |
| | 500 nm at 60 deg [%] | | | | | |
| | Wavelength position of | 667 | 661 | 661 | 676 | 669 |
| | IR10 at 0 deg [nm] | | | | | |
| | Wavelength position of | 655 | 648 | 648 | 666 | 658 |
| | IR10 at 60 deg [nm] | | | | | |
| | IR10(0 deg) − | 12 | 13 | 13 | 10 | 11 |
| | IR10(60 deg) [nm] | | | | | |
| | Average transmittance at | 0.10 | 0.12 | 0.02 | 0.36 | 1.25 |
| | wavelength of 750 nm to | | | | | |
| | 1,000 nm at 0 deg [%] | | | | | |
| | Average transmittance at | 0.02 | 0.03 | 0.01 | 0.10 | 0.47 |
| | wavelength of 750 nm to | | | | | |
| | 1,000 nm at 60 deg [%] | | | | | |
| | Transmittance at wavelength | 0.52 | 0.69 | 0.24 | 1.29 | 6.74 |
| | of 1,100 nm at 0 deg [%] | | | | | |
| | Transmittance at wavelength | 0.13 | 0.18 | 0.17 | 0.38 | 2.94 |
| | of 1,100 nm at 60 deg [%] | | | | | |
| | Maximum transmittance at | 0.25 | 0.21 | 0.06 | 0.68 | 2.85 |
| | wavelength of 750 mm to | | | | | |
| | 1,000 nm at 0 dog [%] | | | | | |
| | Maximum transmittance at | 0.06 | 0.05 | 0.03 | 0.21 | 1.39 |
| | wavelength of 750 nm to | | | | | |
| | 1,000 nm at 60 deg 1%] | | | | | |
| | Maximum reflectance at | 5.1 | 5.1 | 99.7 | 5.2 | 4.8 |
| | wavelength of 450 nm to | | | | | |
| | 950 nm when incident on | | | | | |
| | multilayer film 1 side at | | | | | |
| | 5 deg [%] | | | | | |
| | Maximum reflectance at | 11.7 | 11.7 | 98.4 | 11.8 | 11.4 |
| | wavelength of 450 nm to | | | | | |
| | 950 nm when incident on | | | | | |
| | multilayer film 1 side | | | | | |
| | at 60 deg [%] | | | | | |
| | Difference between average | 6.8 | 8.0 | 10.6 | 6.7 | 6.8 |
| | transmittances at wavelength | | | | | |
| | of 440 nm to 500 nm at 0 deg | | | | | |
| | and 60 deg [%] | | | | | |
| | Maximum reflectance at | 9.1 | 9.1 | 8.9 | 9.2 | 8.8 |
| | wavelength of 450 nm to | | | | | |
| | 950 mn when incident on | | | | | |
| | light-absorbing layer | | | | | |
| | side at 5 deg [%] | | | | | |
| | Maximum reflectance at | 19.8 | 19.8 | 19.9 | 19.9 | 19.4 |
| | wavelength of 450 nm to | | | | | |
| | 950 nm when incident on | | | | | |
| | light-absorbing layer | | | | | |
| | side at 60 deg [%] | | | | | |
| | Average transmittance at | 0.0987 | 0.1333 | 0.0005 | 0.3579 | 1.9869 |
| | wavelength of 900 nm to | | | | | |
| | 1,000 nm at 0 deg [%] | | | | | |

TABLE 8

| | | | Example | Example | Example | Example | Example |
|---|---|---|---|---|---|---|---|
| | | | 2-6 | 2-7 | 2-8 | 2-9 | 2-10 |
| Configuration | Dielectric | Type | 3A | 3A | 3A | 3A | 3A |
| of optical | multilayer | Film | TiO₂/SiO₂ | TiO₂/SiO₂ | TiO₂/SiO₂ | TiO₂/SiO₂ | TiO₂/SiO₂ |
| filter | film 3 | configuration | 8 layers | 8 layers | 8 layers | 8 layers | 8 layers |
| | | Total film | 348 | 348 | 348 | 348 | 348 |
| | | thickness | | | | | |
| | | [nm] | | | | | |
| | Light-absorbing layer | | 1 | 1 | 1 | 1 | 1 |
| | Dielectric | Type | 2A | 2A | 2A | 2A | 2A |
| | multilayer | Film | TiO₂/SiO₂ | TiO₂/SiO₂ | TiO₂/SiO₂ | TiO₂/SiO₂ | TiO₂/SiO₂ |
| | film 2 | configuration | 5 layers | 5 layers | 5 layers | 5 layers | 5 layers |
| | | Total film | 2,142 | 2,142 | 2,142 | 2,142 | 2,142 |
| | | thickness | | | | | |
| | | [nm] | | | | | |
| | Barrier film 2 | Film material | TiO₂ | TiO₂ | TiO₂ | TiO₂ | TiO₂ |
| | | Thickness | 12 | 12 | 12 | 12 | 12 |
| | | [nm] | | | | | |
| | Glass | Type | Glass 1 | Glass 4 | Glass 4 | Glass 7 | Glass 8 |
| | | Thickness | 0.25 | 0.25 | 0.25 | 0.25 | 0.25 |
| | | [mm] | | | | | |
| | Barrier film 1 | Film material | TiO₂ | TiO₂ | TiO₂ | TiO₂ | TiO₂ |
| | | Thickness | 12 | 12 | 12 | 12 | 12 |
| | | [nm] | | | | | |
| | Dielectric | Type | 1A | 1A | 1B | 1A | 1A |
| | multilayer | Film | TiO₂/SiO₂ | TiO₂/SiO₂ | TiO₂/SiO₂ | TiO₂/SiO₂ | TiO₂/SiO₂ |
| | film 1 | configuration | 19 layers | 19 layers | 47 layers | 19 layers | 19 layers |
| | | Total film | 2,843 | 2,843 | 2,892 | 2,843 | 2,843 |
| | | thickness | | | | | |
| | | [nm] | | | | | |

| Results of reliability test: 100 hours | | A | No Data | No Data | A | A |
|---|---|---|---|---|---|---|
| Results of reliability test: 250 hours | | A | No Data | No Data | A | A |
| Spectral | Average transmittance at | 90.0 | 79.8 | 78.5 | 90.5 | 90.0 |
| characteristics | wavelength of 440 nm to | | | | | |
| | 500 nm at 0 deg [%] | | | | | |
| | Average transmittance at | 83.3 | 72.0 | 68.0 | 83.9 | 83.2 |
| | wavelength of 440 nm to | | | | | |
| | 500 nm at 60 deg [%] | | | | | |
| | Wavelength position of | 673 | 669 | 669 | 681 | 675 |
| | IR10 at 0 deg [nm] | | | | | |
| | Wavelength position of | 662 | 656 | 656 | 672 | 664 |
| | IR10 at 60 deg [nm] | | | | | |
| | IR1((0 deg) − | 11 | 13 | 13 | 9 | 11 |
| | IR10(60 deg) [mm] | | | | | |
| | Average transmittance at | 0.29 | 0.34 | 0.04 | 0.85 | 2.44 |
| | wavelength of 750 nm to | | | | | |
| | 1,000 nm at 0 deg [%] | | | | | |
| | Average transmittance at | 0.08 | 0.09 | 0.02 | 0.27 | 1.04 |
| | wavelength of 750 nm to | | | | | |
| | 1,000 nm at 60 deg [%] | | | | | |
| | Transmittance at | 1.21 | 1.53 | 0.53 | 2.59 | 10.28 |
| | wavelength of 1,100 nm | | | | | |
| | at 0 deg [%] | | | | | |
| | Transmittance at | 0.36 | 0.48 | 0.44 | 0.90 | 4.89 |
| | wavelength of 1,100 min | | | | | |
| | at 60 deg [%] | | | | | |
| | Maximum transmittance at | 0.51 | 0.55 | 0.15 | 1.18 | 5.03 |
| | wavelength of 750 nm to | | | | | |
| | 1,000 nm at 0 deg [%] | | | | | |
| | Maximum transmittance at | 0.15 | 0.18 | 0.10 | 0.44 | 2.76 |
| | wavelength of 750 nm to | | | | | |
| | 1,000 nm at 60 deg [%] | | | | | |
| | Maximum reflectance at | 5.1 | 5.1 | 99.7 | 5.2 | 4.8 |
| | wavelength of 450 nm to | | | | | |
| | 950 nm when incident on | | | | | |
| | multilayer film 1 side at | | | | | |
| | 5 deg [%] | | | | | |
| | Maximum reflectance at | 11.7 | 11.7 | 98.4 | 11.8 | 11.4 |
| | wavelength of 450 nm to | | | | | |
| | 950 nm when incident on | | | | | |
| | multilayer film 1 side at | | | | | |
| | 60 deg [%] | | | | | |
| | Difference between | 6.7 | 7.8 | 10.5 | 6.6 | 6.7 |
| | average transmittances | | | | | |
| | at wavelength of 440 nm | | | | | |
| | to 500 nm at 0 deg | | | | | |
| | and 60 deg [%] | | | | | |
| | Maximum reflectance at | 9.1 | 9.1 | 8.9 | 9.2 | 8.8 |
| | wavelength of 450 nm to | | | | | |
| | 950 nm when incident on | | | | | |
| | light-absorbing layer side | | | | | |
| | at 5 deg [%] | | | | | |
| | Maximum reflectance at | 19.8 | 19.8 | 19.9 | 19.9 | 19.4 |
| | wavelength of 450 nm to | | | | | |
| | 950 nm when incident on | | | | | |
| | light-absorbing layer side | | | | | |
| | at 60 deg [%] | | | | | |
| | Average transmittance at | 0.3073 | 0.3948 | 0.0015 | 0.9008 | 3.7508 |
| | wavelength of 900 nm to | | | | | |
| | 1,000 nm at 10 deg [%] | | | | | |

From the above results, it is understood that the optical filters of Examples 2-1 to 2-4 and 2-6 to 2-9 are optical filters that are excellent in transmittance of visible light even at a high incident angle, excellent in shielding properties of near-infrared light of 750 nm to 1,000 nm, particularly, infrared light of 1,000 nm, and have a small shift of spectral curve even at a high incident angle.

According to comparison between Examples 2-4 and 2-9, when the phosphate glass had a low content of CuO, the transmittance at a wavelength of 1,100 nm exceeded 2% in Example 2-9 in which the thickness was reduced to 0.25 mm, and the shielding properties were reduced. Accordingly, it is understood that the content of CuO in the phosphate glass is preferably 12 mol % or more.

The optical filters of Examples 2-5 and 2-10 exhibited low shielding properties of near-infrared light at 750 nm to 1,000 nm and low shielding properties of near-infrared light at 1,000 nm. It is considered that this is because the absorbing properties in such a region are low when the fluorophosphate glass is used.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-135694) filed on Aug. 23, 2023, the content of which is incorporated herein by reference.

### INDUSTRIAL APPLICABILITY

The optical filter of the present invention is excellent in transmittance of visible light and shielding properties of near-infrared light. In recent years, the optical filter has been useful for applications of information acquisition devices such as cameras and sensors for transport machines, for which high performance has been achieved.

### REFERENCE SIGNS LIST

1A, 1B: optical filter
10: phosphate glass
11, 12: barrier film
21, 22, 23: dielectric multilayer film
30: light-absorbing layer

What is claimed is:

1. An optical filter comprising:
a phosphate glass;
a dielectric multilayer film 1 and a dielectric multilayer film 2 provided on both surface sides of the phosphate glass;
a barrier film 1 provided between the phosphate glass and the dielectric multilayer film 1;
a barrier film 2 provided between the phosphate glass and the dielectric multilayer film 2; and
a light-absorbing layer provided on or above the dielectric multilayer film 2, wherein
the phosphate glass has near-infrared ray absorbing properties, is substantially free from fluorine atoms, and has a thickness of 0.3 mm or less,
the light-absorbing layer comprises a near-infrared ray absorbing dye,
the barrier film 1 and the barrier film 2 each independently comprise one or more selected from TiO₂, Nb₂O₅, Ta₂O₅, and HfO₂, and
the optical filter satisfies all of the following spectral characteristics (i-1) to (i-5):
(i-1) an average transmittance at a wavelength of 440 nm to 500 nm is 75% or more at an incident angle of 0 degrees and 60% or more at an incident angle of 60 degrees,
(i-2) an average transmittance at a wavelength of 750 nm to 1,000 nm is 2% or less at an incident angle of 0 degrees and 2% or less at an incident angle of 60 degrees,
(i-3) in a spectral transmittance curve at an incident angle of 0 degrees, a wavelength IR10_{(0 deg)} at which a transmittance is 10% is in a range of 600 nm to 700 nm,
(i-4) an absolute value of a difference between the wavelength IR10_{(0 deg)} at which the transmittance is 10% in the range of 600 nm to 700 nm in the spectral transmittance curve at an incident angle of 0 degrees and a wavelength IR10_{(60 deg)} at which a transmittance is 10% in the range of 600 nm to 700 nm in a spectral transmittance curve at an incident angle of 60 degrees is 15 nm or less, and
(i-5) a transmittance at a wavelength of 1,100 nm is 5% or less at an incident angle of 0 degrees and 5% or less at an incident angle of 60 degrees.

2. The optical filter according to claim 1, wherein
the optical filter satisfies the following spectral characteristic (i-6):
(i-6) a maximum transmittance at a wavelength of 750 nm to 1,000 nm is 2% or less at an incident angle of 0 degrees and 2% or less at an incident angle of 60 degrees.

3. The optical filter according to claim 1, wherein
the phosphate glass has a thickness of 0.25 mm or less, and
the optical filter satisfies the following spectral characteristic (i-7):
(i-7) a transmittance at a wavelength of 1,100 nm is 2% or less at an incident angle of 0 degrees.

4. The optical filter according to claim 1, wherein
the phosphate glass comprises 12% or more of CuO in terms of mol % based on oxides.

5. The optical filter according to claim 4, wherein
the phosphate glass comprises 13% or more of Al₂O₃ in terms of mol % based on oxides.

6. The optical filter according to claim 4, wherein
the phosphate glass comprises 0.1% to 5% of MoO₃ in terms of mol % based on oxides.

7. The optical filter according to claim 1, wherein
the phosphate glass has, in terms of a plate thickness of 0.25 mm,
an average transmittance of 70% or more at a wavelength of 440 nm to 500 nm,
a transmittance of 5.5% or less at a wavelength of 1,200 nm,
a transmittance of 1.0% or less at a wavelength of 1,000 nm, and
a transmittance of 1.5% or less at a wavelength of 800 nm.

8. The optical filter according to claim 1, wherein
the barrier film 1 and the barrier film 2 comprise TiO₂.

9. The optical filter according to claim 1, wherein
each of the barrier film 1 and the barrier film 2 has a thickness of 10 nm or more.

10. The optical filter according to claim 1, wherein
the dielectric multilayer film 1 has a thickness of 1.0 μm or more.

11. The optical filter according to claim 1, wherein
the light-absorbing layer comprises:
one or more near-infrared ray absorbing dyes having a maximum absorption wavelength in a range of 700 nm or more and less than 740 nm; and
one or more near-infrared ray absorbing dyes having a maximum absorption wavelength in a range of 740 nm or more and 800 nm or less.

12. An imaging device comprising the optical filter according to claim 1.
